(19) United States
(12) Patent Application Publication
(10) Pub. No.: US 2025/0197298 A1
(43) Pub. Date: Jun. 19, 2025

(54) PRECERAMIC RESINS AND POLYMER-DERIVED CERAMICS

(71) Applicant: University of Tasmania, Tasmania (AU)

(72) Inventors: Vipul Gupta, Tasmania (AU); Ahmad Reza Norouzi, Tasmania (AU)

(21) Appl. No.: 18/844,782

(22) PCT Filed: Mar. 8, 2023
(86) PCT No.: PCT/AU2023/050159

§ 371 Date: Sep. 6, 2024

(30) Foreign Application Priority Data
Mar. 8, 2022 (AU) 2022900557
May 27, 2022 (AU) 2022901435

(51) Int. Cl. C04B 35/571; C03C 10/00; C04B 35/14; C04B 35/56; C04B 35/64; C09D 7/61; C09D 183/08; C09D 183/10

(52) U.S. Cl. CPC C04B 35/571; C03C 10/0009; C04B 35/14; C04B 35/5603; C04B 35/64; C09D 7/61; C09D 183/08; C09D 183/10; C04B 2235/3418; C04B 2235/3826; C04B 2235/3895; C04B 2235/483; C04B 2235/6026; C04B 2235/6562

(57) ABSTRACT

The present disclosure relates to organosilicon preceramic resin compositions for forming polymer-derived ceramic materials, especially high-shrinkage polymer-derived ceramic materials. It also relates to organosilicon polymer-derived ceramic materials articles and methods for their formation.

### RELATED APPLICATIONS

This application claims the benefit of Australian Provisional Patent Application No 2022901435, filed on 27 May 2022, which is incorporated herein by reference in its entirety.

### TECHNICAL FIELD

The present invention relates to organosilicon-containing preceramic resins for forming polymer-derived ceramic materials. It also relates to polymer-derived ceramic materials, methods for forming polymer-derived ceramic materials, and articles manufactured therefrom.

### BACKGROUND ART

Ceramic material articles are widely used in various socio-economically important applications, such as sustainable energy production and storage, drug development, environment and health monitoring and engineering fields. Specific applications include high-speed impellers, heat shielding and wear-resistant parts. Their use arises from ceramic materials generally being characterized by impressive thermal stability and mechanical strength. However, because of this, they are difficult to machine into specific shapes required for their various applications.

This has been aided by the development of polymer-derived ceramic (PDC) materials which allow pre-shaping of a softer, more malleable preceramic polymeric precursor before converting the shaped article into a ceramic.

The common process for making PDC materials involves subjecting a preceramic polymer article to pyrolytic conditions at temperatures in excess of 1000° C. This causes a thermally-induced conversion from organic to inorganic (i.e. ceramic) material and thermal decomposition of certain components of the preceramic polymer. Decomposition tends to release gases
which may include carbon dioxide, carbon monoxide, methane, water and others. This tends to produce solid, nonporous PDC materials.

Ceramic manufacturing has been assisted by the recent advent of 3D printing in which a preceramic polymer, silane, or a ceramic and organic binder composite is printed to shape prior to pyrolysis or sol-gel processing. However, 3D printing of ceramics is still in its infancy. Most of the ceramic 3D printing methods have been limited to the use of direct ink writing technique, which restricts their use to the formation of relatively simple articles produced with low resolution. More recently, photopolymerisation based 3D printing techniques, such as stereolithography, that improves upon direct ink writing, have been explored to produce ceramic articles. However, these methods still have significant resolution limitations such that articles only so small can be produced, or articles containing features only so fine can be produced.

The field of microfabrication has further progressed in recent years assisted by the advent of 3D printing techniques and advances in other techniques such as injection moulding. However, there still remains limits to how small in size articles or article features may be produced using microfabrication techniques. Microfabrication using 3D printing for example is predominantly limited to a few photopolymers which are usually composed of short organic chain acrylate and epoxy monomers which cannot be pyrolysed to produce ceramic materials. These polymeric materials lack various desirable properties, such as chemical and thermal resistance, high mechanical strength, and biocompatibility, which excludes their use from many high-value applications. The properties of the photopolymers also place a limit on the resolution obtainable—articles only so small are producible, or articles containing features only so fine are producible. While the use of silicon-based ceramics can improve upon the properties of manufactured articles for high value applications, microfabrication including 3D printing of silicon-based ceramics is limited to low-resolution applications due in large part to the inherent physio-chemical properties of the print materials.

Ceramic materials have impressive properties that are desirable to implement in many fields of endeavour which rely on microfabricated articles, though limitations in the inherent physio-chemical properties of their resins and difficult methods of manufacture, prevents them from being adopted in a broader array of applications. It would be beneficial to provide preceramic resins for the production of alternative PDC materials that may be utilised in new and existing microfabrication applications. It would also be beneficial to provide effective methods for the manufacture of microfabricated ceramic articles or articles containing microstructures.

### SUMMARY

The present invention is predicated on the acquired knowledge that certain components used in a preceramic resin give rise to PDC materials formed by a process of pyrolysis of a polymerised green body, which are characterized by high shrinkage as compared to the green body, and ways of exploiting that shrinkage.

Accordingly, in one aspect the present invention provides a preceramic resin for forming a polymer-derived ceramic material, said resin comprising a first functionalised organosilicon monomer having a first ceramic yield of no greater than 50%, and one or more of:
a) a second functionalised organosilicon monomer having a second ceramic yield, wherein the second ceramic yield is greater than the first ceramic yield by at least 5%; and
b) ceramic particles.

In particular embodiments, the preceramic resin comprises one of the following combinations selected from (a) to (c) below:
a) a first functionalised organosilicon monomer having a first ceramic yield of no greater than 50% and a second functionalised organosilicon monomer having a second ceramic yield which is greater than the first ceramic yield by at least 5%;
b) a first functionalised organosilicon monomer having a first ceramic yield of no greater than 50% and ceramic particles; and
c) a first functionalised organosilicon monomer having a first ceramic yield of no greater than 50% and, a second functionalised organosilicon monomer having a second ceramic yield which is greater than the first ceramic yield by at least 5%, and ceramic particles.

In another aspect, the present invention provides a polymer-derived ceramic material formed from a preceramic resin as described herein.

In another aspect, the present invention provides a polymer-derived ceramic material formed by pyrolysis of a green body, characterised by a linear shrinkage of greater than or equal to 30% and a volumetric shrinkage of greater than or equal to about 66%.

In another aspect, the present invention provides a polymer-derived silica ceramic material formed by pyrolysis of a green body, characterised by a linear shrinkage of greater than or equal to 20% and a volumetric shrinkage of greater than or equal to about 49%.

In another aspect, the present invention provides a polymer-derived glass-ceramic material.

In another aspect, the present invention provides a manufactured PDC article comprising a channel.

In another aspect, the present invention provides a manufactured macrostructure PDC article comprising a microstructure.

In another aspect, the present invention provides a method for forming a polymer-derived ceramic material, said method comprising:
a) subjecting a preceramic resin as herein described to polymerising conditions to form a preceramic polymer; and
b) subjecting the preceramic polymer to pyrolytic conditions to form a polymer-derived ceramic material.

In another aspect, the present invention provides a method for forming a polymer-derived ceramic material, said method comprising:
a) subjecting a preceramic resin for forming a polymer-derived ceramic material to polymerising conditions to form a preceramic polymer; and
b) subjecting the preceramic polymer to pyrolytic conditions to form a polymer-derived ceramic material,
wherein formation of the polymer-derived ceramic material from the preceramic polymer proceeds through a porous phase, and wherein the pyrolytic conditions comprise a temperature ramp-up rate of no greater than 10° C./minute for a period within the porous phase.

In another aspect, the present invention provides a method for forming a polymer-derived ceramic material, said method comprising:
a) subjecting a preceramic resin for forming a polymer-derived ceramic material to polymerising conditions to form a preceramic polymer; and
b) subjecting the preceramic polymer to pyrolytic conditions to form a polymer-derived ceramic material,
wherein the pyrolytic conditions comprise a temperature ramp-up rate of no greater than 10° C./minute for a period within the temperature range of 200 to 900° C.

In another aspect, the present invention provides a polymer-derived ceramic material formed from a method as described herein.

### DESCRIPTION OF THE FIGURES

FIG. 1 shows a 3D printed and shrink-fabricated glass-ceramic bifurcating microfluidic distributor formed using a low ceramic yield PDC monomer and a high ceramic yield PDC monomer in 1:1 weight ratio: (a) top view of the printed distributor, (b) side view of the printed distributor, (c) side view of the pyrolysed distributor, and (d) SEM image of a closed channel.

FIG. 2 shows material characteristics of the printed silicon oxycarbide glass-ceramic using (a) Energy Dispersive X-ray spectroscopy, (b) transmission electron microscopy, (c) Raman Spectroscopy, and (d) X-ray Diffraction Spectroscopy.

FIG. 3 shows a 3D printed and shrink-fabricated glass-ceramic microneedle patch formed using a low ceramic yield PDC monomer and a high ceramic yield PDC monomer in 1:1 weight ratio: (a) top view of the printed microneedles, (b) side view of the printed microneedles, (c) side view of the pyrolysed microneedles, and (d) SEM image of a microneedle.

FIG. 4 shows a 3D printed and shrink-fabricated ceramic disc formed using a low ceramic yield PDC monomer and a high ceramic yield PDC monomer in 1:2 weight ratio: (a) green body and (b) pyrolyzed body.

FIG. 5 shows a 3D printed and shrink-fabricated ceramic disc formed using a single low ceramic yield PDC monomer with ceramic particles: (a) green body and (b) pyrolysed body.

FIG. 6 shows a 3D printed and shrink-fabricated ceramic block formed using a low ceramic yield PDC monomer and a high ceramic yield PDC monomer along with ceramic particles: (a) green body and (b) pyrolyzed body.

FIG. 7 shows a 3D printed and shrink-fabricated ceramic block formed using a low ceramic yield PDC monomer and a high ceramic yield PDC monomer along with ceramic particles: (a) green body and (b) pyrolyzed body.

FIG. 8 shows a 3D printed and shrink-fabricated ceramic disc formed using a low ceramic yield PDC monomer and a high ceramic yield PDC monomer along with ceramic particles: (a) green body and (b) pyrolyzed body.

FIG. 9 shows an attempt at forming a 3D printed and shrink-fabricated ceramic disc using a single low ceramic yield PDC monomer: (a) green body and (b) pyrolysed body.

FIG. 10 shows a 3D printed and shrink-fabricated ceramic pyramid with microstructure scaffold formed using a low ceramic yield PDC monomer and a high ceramic yield PDC monomer in 1:1 weight ratio: (a) side view of the printed pyramid and (b) side view of the pyrolysed pyramid.

FIG. 11 shows a 3D printed and shrink-fabricated porous ceramic microfluidic chip formed using a low ceramic yield PDC monomer and a high ceramic yield PDC monomer along with ceramic particles.

FIG. 12 is a schematic of a real-time Fourier-transform infrared (RT-FTIR) spectroscopy setup used to study photo-polymerisation reaction kinetics.

FIG. 13 contains a graph of the RT-FTIR shelf-life study when samples are stored at 4° C. over 27 days, as observed from the change in their C═C stretching, based on the resin of Examples 1 and 2.

FIG. 14 plots resin curing depth and polymerisation percentage as observed with respect to the exposure time in oxygen resistance studies on a resin of Examples 1 and 2 resin (based on thiol-acrylate chemistry) and of Example 8 (based on acrylate chemistry).

FIG. 15 contains graphs of the functional group ratio study of the resin used in Example 1 using different molar ratios of acrylate and thiol functional groups on the reaction kinetics: (a) total percentage polymerisation; (b) gel point; and (c) resin ceramic yield.

### DETAILED DESCRIPTION

Unless defined otherwise, all technical and scientific terms used herein have the same meaning as commonly understood by those of ordinary skill in the art of the invention. Although any methods and materials similar or equivalent to those described herein can be used in the practice or testing of the present invention, preferred methods and materials are described. For the purposes of the present invention, a number of terms are defined throughout.

Manufactured PDC materials are generally formed by a process which involves the polymerisation of a preceramic resin to form a preceramic polymer, and pyrolysis of the preceramic polymer. Generally speaking, during pyrolysis a preceramic resin is converted from an organic to an inorganic material. The inorganic material may exist in one or more material phases depending on the temperature to which the material is exposed. For instance, during pyrolysis temperature ramp-up, the organic material will generally first exist in an amorphous phase and then transition to a crystalline phase as the temperature increases. The present invention is concerned with the pyrolysis of preceramic resins which contain certain components as detailed herein, to give PDC materials which are characterized by high shrinkage, and optionally existing in a selected phase.

Without wishing to be limited by theory, it is thought that certain components of the preceramic resins as detailed herein give rise to the presence of pores during pyrolysis which allow liquids and gasses to escape more easily and in greater volume, resulting in controlled shrinkage. In some embodiments, depending on the conditions applied, the pores may then collapse leading to a higher overall degree of shrinkage. The formation of pores and optional collapse is believed to reduce the likelihood of breakdown in the integrity of the resulting PDC material. That is, in other words, and generally speaking, the components of the preceramic resins are such that they may be capable of resulting in pores being contained in the material during pyrolysis.

Also, it is thought that certain components of the preceramic resins are capable of giving rise to pyrolysed glass-ceramic PDC materials containing PDC material as both amorphous silica and PDC material in a crystalline phase. Glass-ceramic materials may be characterised by particularly favourable mechanical and chemical properties. The components of the preceramic resins may thus also be capable of forming glass-ceramic PDC materials.

As used herein, a “polymer-derived ceramic” (PDC) material is a manufactured ceramic material formed by pyrolysis of a preceramic polymer, and is as distinct from a naturally-occurring ceramic material.

Amorphous silica-based inorganic materials are often referred to as “glass”. Accordingly, by “glass-ceramic” is meant a material containing PDC glass and crystalline PDC material. Expressed in alternative terms, a PDC glass-ceramic may be described as a PDC material containing glass material interspersed with or otherwise existing alongside a phase-separated crystalline PDC material.

The term “preceramic” confers a capability of being formed into a ceramic material using, either alone or with other steps of a method, a step of pyrolysis. Thus, a “preceramic polymer” is a polymeric material formed by subjecting a monomer to polymerising conditions, and which is capable of being pyrolysed into a ceramic material. In turn, a “preceramic resin” is a material containing at least one monomer which is capable of being polymerised to form a preceramic polymer. Such a monomer may be referred to as a “preceramic monomer”.

The present invention is directed towards resins comprising such monomeric materials that are suitable to be formed into polymeric materials and then into manufactured PDC materials. That is, the resins of the present invention find particular utility in forming manufactured PDC material articles from shaped preceramic polymer articles (also known as “green bodies”). The resins may be suitable for forming ceramic articles containing microstructures.

A “microstructure” as used herein generally refers to a structure characterisable by a dimension of less than 1 mm and particularly by a dimension of between about 1 micron and less than 1 mm, and includes a structure that is a part of a larger article. By “structure” is meant a physical feature or dimension of an article. To use an example, a cylindrical protrusion from a flat surface with a height of 50 microns and a diameter of 50 microns may be described as being a microstructure, or a structure with dimensions within the microstructure range. A structure may also be a feature characterized by an absence of a substance (i.e. “negative feature”)—such as a cylindrical bore within a flat surface with a depth of 50 microns and a diameter of 50 microns. As a further example, a controlled series of steps with 50 micron rises and 50 micron runs that is built into a larger-dimensioned article or “macrostructure” (for example, a square-based pyramid of 2 cm in height) may be described as having microstructure. What distinguishes a microstructure from microscopic irregularities in a surface is the controlled formation or controlled arrangement of the micro-scale features in the microstructure, as distinct from random or irregular microscopic features.

In preferred embodiments, the PDC articles contain a microstructure as part of a larger article. That is, the PDC article may itself be a macrostructure which contains a microstructure. A “macrostructure” as used herein generally refers to a structure characterisable by a dimension of greater than or equal to 1 mm. For example, the PDC article may be characterised by one or more of the three principle dimensions of three-dimensional space (i.e. as is commonly represented by X-, Y- and Z-axis) of 1 mm to 100 mm, and preferably from 1 mm to 50 mm, more preferably from 1 mm to 10 mm. An example of an article with a microstructure is an article with a microchannel as herein described. Of course, the dimensions of the green body will be larger by a factor accounting for the degree of shrinkage. For example, the dimensions of a green body used to form a 10 mm cube PDC article characterised by a linear shrinkage of 50% will be double; that is, a 20 mm cube green body.

The applicability of the resins of the present invention to forming macrostructures is surprising. Traditionally, the formation of macrostructures has been very difficult as larger article have been prone to breakdown in the integrity of the PDC material. However, in the present invention it has been found that the combination of the resin components as herein described allows for the formation of macrostructures without, or with reduced risk of, breakdown of the PDC material.

Green bodies may be formed by shaping processes known in the art. Shaping processes particularly applicable to the present invention are injection moulding methods such as liquid silicone rubber injection moulding, and 3D printing methods such as stereolithography, digital light projection, two-photon lithography, continuous liquid interface methods, direct ink writing and inkjet printing. These methods are generally known in the art.

The PDC materials are particularly suited to be formed into microfabricated ceramic articles and ceramic articles containing microstructures because the resins as described herein, when formed into a green body and pyrolysed, tend to undergo a high degree of linear and volumetric shrinkage thereby forming PDC materials that are much smaller than the green bodies from which they are pyrolysed. This is because, during pyrolysis, a preceramic polymer will generally undergo a certain degree of linear and volumetric shrinkage as the material undergoes a thermally-induced conversion from organic to inorganic material and liquids and gases are expelled. The present inventors have found that resins which contain porosity prior to, or which introduce porosity to the material during, pyrolysis, may undergo a degree of linear and volumetric shrinkage greater than those in which there is no or a lesser extent of porosity. Without wishing to be limited by theory, it is thought that porosity which exists at least for a time during pyrolysis allows for the escape of a greater volume of liquids and gases through both providing escape pathways and exposing an increased surface area of the material by virtue of the porosity to pyrolytic conditions to undergo pyrolysis. The principle finding of formation of pores in the formation of PDC materials is described in the specification for Australian patent application number 2022900557 which is herein incorporated by reference in its entirety. The formation of pores also assists to reduce the likelihood of or avoid deformation, cracking and/or other breakdown in the integrity of the PDC material by allowing liquids and gasses to escape, which assists to avoid pressure build-up within the material which may lead to said breakdown. The pores may then be made to collapse during continued pyrolysis which may result in a higher degree of linear and volumetric shrinkage in the resulting PDC material.

By “porous” or having “porosity” is meant the containing of pores. A “pore” is a space which is devoid of the solid material that makes up the material. Pores may be considered hierarchically in terms of pore size, as micropores, mesopores and macropores. A “micropore” refers to a pore with a diameter of less than 2 nm. A “mesopore” refers to a pore with a diameter of from 2 nm to 50 nm. A “macropore” refers to a pore with a diameter of from 50 nm to 100 micrometres. Macropores may further be considered as sub-, inter- and super-macropores, which refers to a macropore with a diameter of from 50 nm to 1 micrometre, from 1 micrometre to 10 micrometres, and from 10 micrometres to 100 micrometres, respectably. By “diameter” does not limit the shape of a pore and refers to the greatest axial dimension. Similarly, “microporous” refers to the containing of micropores, while “mesoporous” refers to the containing of mesopores, and “macroporous” refers to the containing of macropores. Pore size may be experimentally determinable using methods known in the art. Known methods include gas adsorption (including using a BET surface analyser), scanning electron microscopy and liquid intrusion (including mercury porosimetry). Similarly, porosity is directly related to specific surface area—the greater the porosity, the greater the specific surface area. Specific surface area is experimentally determinable using methods known in the art including gas adsorption (including using a BET surface analyser) and liquid intrusion (including mercury porosimetry).

Traditionally, shrinkage has been regarded as a negative attribute in the manufacture of PDC materials from preceramic resins, and efforts have been made to minimise or prevent it. The present inventors, on the other hand, have come to realise that shrinkage may be exploited, especially as applied to the art of microfabrication, and have developed preceramic resins as described herein which result in increased shrinkage via (though without wishing to be limited by theory) the presence of pores during pyrolysis.

Methods for determining linear and volumetric shrinkage are known in the art and are based on measurements of physical dimension, for example the length, of a PDC material article as compared to that of the preceramic polymer article or green body. Linear shrinkage may be classified as high, medium and low. “High linear shrinkage” refers to a linear shrinkage that is greater than or equal to 20%. “Medium linear shrinkage” refers to a linear shrinkage which is between 15% and 20%. “Low linear shrinkage” refers to a linear shrinkage which is less than or equal to 15%. Volumetric shrinkage may be similarly classified such that “high volumetric shrinkage” refers to a volumetric shrinkage that is greater than or equal to 48.8% (i.e. about 49%), “medium volumetric shrinkage” refers to a volumetric shrinkage which is between 38.6% (i.e. about 39%) and 48.8% (i.e. about 49%), and “Low volumetric shrinkage” refers to a volumetric shrinkage which is less than or equal to 38.6% (i.e. about 39%). The present invention provides for PDC materials with high linear shrinkage and high volumetric shrinkage, and in some embodiments even provides for a linear shrinkage of about or greater than 30% and even about or greater than 45% or about or greater than 50%, and volumetric shrinkage of about or greater than 65.7% (i.e. about 66%) and even about or greater than 83.4% (i.e. about 84%) or about or greater than 87.5% (i.e. about 88%) which may be described as “very high linear shrinkage” and “very high volumetric shrinkage”, respectably.

This allows for the manufacture of PDC articles containing microstructures that are smaller than previously obtainable. It also allows for the manufacture of sub-resolution PDC articles containing microstructures; that is, smaller than the smallest practical resolution obtainable by the method used to form a green body. For example, many benchtop 3D printers have a lowest practical resolution (as determined by the properties of the resin printed, e.g. its viscosity etc.) of about 500 microns. By exploiting the high shrinkage potential of preceramic resins formulated according to the present invention, microstructures may be formed having a resolution of much less, as a function of the high shrinkage. This includes at sub-resolution dimensions. That is, by exploiting the high shrinkage potential of resins of the present invention in forming PDC materials allows, for example, a preceramic polymer shaped article itself or having a microstructure printed using a benchtop 3D printer with lowest practical resolution of about 500 microns, a PDC article or microstructure of dimensions much smaller, for example of about 250 microns, may be formed as a function of the shrinkage of the PDC material during pyrolysis.

The term “linear shrinkage” is used herein as it is generally understood in the art, to be interchangeable with the term isometric shrinkage; that is, as may be defined by shrinkage in the three principle dimensions of three-dimensional space (i.e. as is commonly represented by X-, Y- and Z-axis), relative to the green body, or as may be generally be understood as being shrinkage in all directions. “Volumetric shrinkage” refers to shrinkage in volume. Linear shrinkage and volumetric shrinkage are directly related. For example, a PDC article characterised by 30% linear shrinkage relative to the green body is also characterisable by a volumetric shrinkage of about 66%. The relationship is demonstrated using the following chart for a cube green body of starting dimensions 10 cm in the three principle dimensions and starting volume 1,000 cm³.

| | | | |
|---|---|---|---|
| Linear | End | End | Volumetric |
| shrinkage | dimension | volume | shrinkage |

| | | | | | |
|---|---|---|---|---|---|
| 5% | 9.5 | cm | 857.375 | cm³ | 14.3% |
| 10% | 9 | cm | 729 | cm³ | 27.1% |
| 15% | 8.5 | cm | 614.125 | cm³ | 38.6% |
| 20% | 8 | cm | 512 | cm³ | 48.8% |
| 25% | 7.5 | cm | 421.875 | cm³ | 57.8% |
| 30% | 7 | cm | 343 | cm³ | 65.7% |
| 35% | 6.5 | cm | 274.625 | cm³ | 72.5% |
| 40% | 6 | cm | 216 | cm³ | 78.4% |
| 45% | 5.5 | cm | 166.375 | cm³ | 83.4% |
| 50% | 5 | cm | 125 | cm³ | 87.5% |
| 55% | 4.5 | cm | 91.125 | cm³ | 90.9% |

The articles produced may find use in numerous engineering and scientific fields in which ceramic materials are employed, and because the PDC materials may be shrunk to a high degree relative to the green bodies, this opens the PDC materials to new utility in applications using microstructures, including microfluidics and medical devices. This is especially the case with applications which use channels, as the present invention allows the formation of PDC articles comprising a channel. The PDC article itself may be a channel or the PDC article may be formed with one or more channel features. The channel may be of any size fit for purpose; for example having a diameter of from micrometer to millimeter or even centimetre dimensions or larger, though particular utility is found with small diameter applications.

That is, microfluidics and medical devices are particular cases in point, as the present invention allows the fabrication of PDC articles comprising a channel of minute sizes, or in other words a microchannel, such as those of microfluidic distributors and microneedle patches. This includes a channel with a diameter of less than or equal to 500 microns, preferably less than or equal to 400 microns, preferably less than or equal to 300 microns and preferably of about 250 microns or 150 microns. Example channel diameters may be expressed as a range. For example, a suitable channel diameter is about 50 microns to about 500 microns, preferably about 100 microns to about 400 microns, preferably about 100 microns to about 300 microns and preferably of about 100 microns to about 250 microns, or of about 150 microns. A “channel” is a structure capable of directionally conveying a liquid and includes both an open and a closed channel (e.g. a capillary). In preferred embodiments, the channel is a microchannel, and a microstructure forming part of a macrostructure PDC article.

The preceramic resins described herein may also give rise to dense PDC structures, including dense glass-ceramic structures. In some embodiments, the density of a glass-ceramic PDC structure may be greater than about 1,500 kg/m³, or greater than about 1,600 kg/m³, or greater than about 1,700 kg/m³, or greater than about 1,800 kg/m³, or greater than about 1,900 kg/m³, or greater than about 2,000 kg/m³. The density of glass-ceramic structures formed may be expressed as a range. In some embodiments, the density may be between about 1,500 kg/m³ and 3,000 kg/m³, or between about 1,600 kg/m³ and 3,000 kg/m³, or between about 1,700 kg/m³ and 2,800 kg/m³, or between about 1,800 kg/m³ and 2,800 kg/m³, or between about 1,900 kg/m³ and 2,700 kg/m³, or between about 2,000 kg/m³ and 2,600 kg/m³. It is to advantage that dense glass-ceramic structures are provided by the present disclosure as discussed further below.

### Preceramic Monomers

A preceramic monomer is characterisable by a ceramic yield. A “ceramic yield” refers to the mass of PDC material obtainable by pyrolysis, expressed as a percentage of the mass of the preceramic monomer (i.e. the mass of the converted PDC material as a percentage of the preceramic material). For example, a preceramic monomer when 10 g of PDC material is formed by pyrolysis of 11 g of preceramic monomer has a ceramic yield of 10/11*100=91%.

The ceramic yield of a preceramic monomer is a chemical property generally influenced by the chemical structure of the monomer. Methods for determining the ceramic yield of a preceramic monomer are known in the art and generally involve subjecting the preceramic monomer to pyrolysing conditions in a thermogravimetric analyser (TGA). Generally, in TGA the weight of a preceramic monomer is measured during pyrolysis as it undergoes conversion to a PDC material. The maximum pyrolysis temperature is usually at least about 600° C. and is often about 850° C. to ensure complete conversion to PDC material. Complete conversion is generally indicated by an experimentally-determined zero weight change between time points at the maximum pyrolysis temperature. A TGA may be capable of determining a starting weight and a final weight following pyrolysis, and from this the ceramic yield can be calculated. A detailed methodology is provided in the Examples. In preferred embodiments, ceramic yield is determined using this method, which may herein be referred to as “TGA₈₅₀ ceramic yield” or “TGA₈₅₀ method”, “850” representing the maximum temperature reached during the analysis.

Ceramic yield may be classified as high, medium and low. “High ceramic yield” refers to a ceramic yield that is greater than or equal to 60%. “Medium ceramic yield” refers to a ceramic yield which is between 30% and 60%. “Low ceramic yield” refers to a ceramic yield which is less than or equal to 30%. The present invention also employs organosilicon monomers having a ceramic yield (including a TGA₈₅₀ ceramic yield) of less than or equal to 20%, which may be referred to a “very low ceramic yield”.

The present invention uses preceramic resins comprising functionalised organosilicon monomers.

An “organosilicon” is a chemical compound with a chemical structure that contains silicon atoms covalently bonded to carbon atoms. Preceramic organosilicon monomers are generally based on a long-chain backbone structure of repeating silicon atom-containing motifs, and in that sense they are generally polymeric materials themselves. Examples applicable to the present invention include polysiloxanes, polycarbosiloxanes, polysilsesquioxanes, polycarbosilanes, polysilylcarbodiimides, polysilsesquicarbodiimides, polysilazanes, polysilsesquiazanes, polyborosilanes, polyborosiloxanes and polyborosilazanes. As silicon and carbon atoms are generally tetravalent, an organosilicon, including the backbone structure of polymeric monomers, is generally substituted with carbon-containing organic chemical groups. By “substituted” in reference to an organosilicon is meant that any one or more hydrogen atoms bound to an atom under consideration is replaced, provided that the atom's valence is not exceeded and a stable compound results. Non-limiting examples of suitable substituents include those of the R-groups as defined below.

### First Organosilicon Monomer

In preferred embodiments, the first organosilicon monomer is selected from one or more of a polysiloxane, polycarbosiloxane, polycarbosilane, polysilylcarbodiimide and a polysilazane having the following chemical structures of Formula 1, Formula 2, Formula 3, Formula 4 and Formula 5:

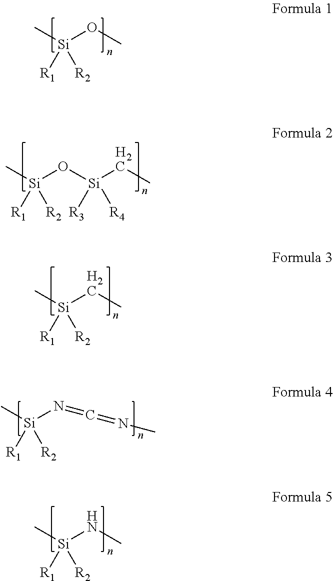

wherein:
n represents a backbone structure of repeating silicon atom-containing motifs and is independently an integer of from 2 to 15; and
R₁, R₂, R₃ and R₄ are independently selected from the group consisting of H, a C₁-C₁₈ substituted or unsubstituted alkyl, a C₁-C₁₈ substituted or unsubstituted alkyl ether, a phenyl and a halide, independently for each integer of n, with the proviso that the pairs of R₁ and R₂ and R₃ and R₄ are not both H, alkyl ether or halide for every integer of n. Preferably, the pairs of R₁ and R₂ and R₃ and R₄ are not both H, alkyl ether or halide for any integer of n. Preferably, each of R₁ and R₂ and R₃ and R₄ are identical for every integer of n.

In formulas 2, 3 and 5, the hydrogen atoms of the CH₂ and NH groups may also be substituted with one or more groups as defined for R₁. As stated above, an organosilicon is a chemical compound with a chemical structure that contains silicon atoms covalently bonded to carbon atoms, which includes organosilicon monomers of formulas 1 to 5 where n is an integer equal to 1. That is, in formulas 1 to 5, n may independently be an integer of 1 or more, or from 1 to 15.

The first organosilicon monomer may also be a polyoctahedral silsesquioxane, preferably selected from one or more of a polysilsesquioxane, polysilsesquicarbodiimide and a polysilsesquiazane substituted with one or more groups as defined for R₁. In other words, the polyoctahedral silsesquioxane may be substituted with one or more groups selected from the group consisting of a C₁-C₁₈ substituted or unsubstituted alkyl, a C₁-C₁₈ substituted or unsubstituted alkyl ether, a phenyl and a halide.

The first organosilicon monomer may also be selected from one or more of a polyborosilane, a polyborosiloxane and a polyborosilazane having the following chemical structures of Formula 6, Formula 7 and Formula 8:

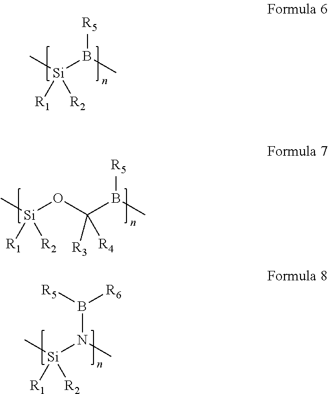

wherein:
n represents a backbone structure of repeating silicon atom-containing motifs and is independently an integer of from 2 to 15;
R₁, R₂, R₃ and R₄ are as defined above; and
R₅ and R₆ are independently selected from the group consisting of H, OH, a C₁-Cis substituted or unsubstituted alkyl, a C₁-C₁₈ substituted or unsubstituted alkyl ether and a phenyl, independently for each integer of n. Like for R₁, R₂, R₃ and R₄, preferably R₅ and R₆ are identical for every integer of n.

In more preferred embodiments, the first organosilicon monomer is selected from one or more of a polysiloxane, polycarbosiloxane and a polycarbosilane wherein n is independently an integer of from 2 to 5 and R₁, R₂, R₃ and R₄ are identical for every integer of n and independently selected from the group consisting of H, methyl and isobutyl, with the proviso that the pairs of R₁ and R₂ and R₃ and R₄ are not both H, and a polysilsesquioxane substituted with a group as defined for R₁ and preferably isobutyl.

In most preferred embodiments, the first organosilicon monomer is a polysiloxane wherein n is independently an integer of from 2 to 5 and R₁, R₂, R₃ and R₄ are identical for every integer of n and independently selected from the group consisting of H, methyl and isobutyl, with the proviso that the pairs of R₁ and R₂ and R₃ and R₄ are not both H.

As stated above, an organosilicon is a chemical compound with a chemical structure that contains silicon atoms covalently bonded to carbon atoms, which includes organosilicon monomers of formulas 6 to 8 where n is an integer equal to 1. That is, in formulas 6 to 8, n may independently be an integer of 1 or more, or from 1 to 15.

As a preceramic monomer is one which is polymerisable then an organosilicon monomer that is “functionalised” is one which contains a polymerisable functional group. The polymerisable functional group may be substituted at one or more points of the organosilicon including, in the case of polymeric organosilicon monomers, at any point(s) along the backbone structure. Alternatively, or in addition, and especially in the case of polymeric organosilicon monomers, the polymerisable functional group may be terminally substituted, i.e. at one or more end groups of the backbone structure. By “substituted” in reference to a functionalised organosilicon is meant that any one or more non-polymerisable chemical groups bound to an atom under consideration is replaced by a polymerisable functional group, provided that the atom's valence is not exceeded and a stable compound results. Non-limiting examples of suitable substituents include those of the polymerisable functional groups defined below.

Accordingly, the first functionalised organosilicon monomer may be obtained by substituting any one or more of R₁, R₂, R₃ and R₄, or a terminal group(s) of the monomer, with one or more of one or more types of polymerisable functional groups. Polymerisable groups of different “types” are those having different chemical structures. The type of functional group(s) used is not particularly critical provided that it provides for polymerization of the monomer(s).

In resins with a first but not a second functionalised organosilicon monomer, one type of polymerisable functional group may be used, selected such that it reacts with itself, or alternatively two or more types of functional groups may be present in the first functionalised organosilicon monomer, selected such that they react with (i.e. are complementary to) each other. Alternatively, or in addition, the first functionalised organosilicon monomer may be crosslinked by a crosslinking agent (comprising a crosslinker group), in order to crosslink the monomers of the resin.

In preferred embodiments, because the resins of the invention find particular utility in forming shaped preceramic polymer articles by 3D printing and injection moulding methods which often rely on thermal- and/or photopolymerization, the polymerisable functional group is compatible with these methods and as such is thermal- or photopolymerisable. In which case, the polymerisable functional group(s) are preferably selected from a group, or a group containing a motif, selected from one or more of an ester, amine, hydroxyl, epoxide, vinyl, allyl, ethynyl, thiol, glycidyl, isocyanurate, alkacrylate, cyano, cyanate and thiocyanate. In preferred embodiments, the first functionalised organosilicon monomer contains one polymerisable functional group type, and is preferably an allyl, a vinyl, a thiol or an acrylate, more preferably a thiol or an acrylate.

In preferred embodiments, the first functionalised organosilicon monomer is characterisable by a high degree of polymerisation. By “degree of polymerisation” refers to the polymerisation yield, being the ratio of crosslinked functional groups to uncrosslinked functional groups in a green body (i.e. relative to what it is intended to polymerise with, for example whether itself or a second functionalised organosilicon monomer). A “high degree of polymerisation” refers to a polymerisation yield that is greater than 80% and includes a “very high degree of polymerisation” that is greater than or equal to 90%, even greater than or equal to 95% or greater than or equal to 98%, and also includes “complete polymerisation” that is greater than or equal to 99% or practically detectably 100%. This is as opposed to “medium polymerisation” that is a polymerisation yield of between 60% and 80% and “low polymerisation” that is a polymerisation yield of less than or equal to 60%. The applicability of a first functionalised organosilicon monomer characterisable by a high degree of polymerisation to obtaining high shrinkage PDC materials is surprising. Traditionally it is thought that a low degree of polymerisation is conducive to obtaining high shrinkage PDC material because there remains a high degree of uncrosslinked residual monomer which burns off during pyrolysis thereby removing a greater amount of material towards higher shrinkage. However, in the present invention it has been found that, though without wishing to be limited by theory, the preceramic resins as described herein which are capable of forming pores during pyrolysis may result in high shrinkage PDC materials even with monomers of high degree of polymerisation. This is advantageous to minimise wasted material and to result in a comparatively stronger and denser PDC material that is less prone to cracking or other breakdown in the integrity of the PDC material. This is particularly advantageous in the formation of silica PDC material and other PDC materials that do not contain carbon, as carbon is thought to assist to maintain PDC material integrity. Thiol-ene and thiol-acrylate chemistry is particularly preferred for providing a high degree of polymerisation, meaning that in preferred embodiments, especially when a second organosilicon monomer is included as explained below, the first functionalised organosilicon monomer contains a polymerisable functional group that is preferably an allyl, a vinyl, a thiol or an acrylate, and is more preferably a thiol or an acrylate.

The first functionalised organosilicon monomer may be selected as described above which has a first ceramic yield (preferably a TGA₈₅₀ ceramic yield) of no greater than 50%. This includes a first ceramic yield of anywhere from 5% to 50%, for example a range that has a lower end value for the range of either 5% 10%, 15%, 20%, 25%, 30%, 35%, 40% or 45%, with the upper end value of the range being 50%. In preferred embodiments, the first functionalised organosilicon monomer has a low ceramic yield which includes a first ceramic yield of anywhere from 5% to 30%, for example, within a range that has a lower end value of 5% and up to a maximum of 10%, 15%, 20%, 25% or 30%. Preferably the first functionalised organosilicon monomer has a very low ceramic yield which includes a first ceramic yield of anywhere from 5% to 20%, for example 5%, 6%, 7%, 8%, 9%, 10%, 11%, 12%, 13%, 14%, 15%, 16%, 17%, 18%, 19% or 20%.

A first ceramic yield of no greater than 50% gives rise to an advantage of the present invention. Without wishing to be limited by theory, it is thought that a first ceramic yield of no greater than 50% along with one or more of a second functionalised organosilicon monomer having a second ceramic yield at least 5% greater than the first and ceramic particles, leads to the formation of high degree of porosity during pyrolysis allowing a greater volume of liquids and gases to escape, which then collapses during pyrolysis providing high shrinkage. Generally speaking, this advantage is increased the lower the first ceramic yield.

In preferred embodiments, the first functionalised organosilicon monomer is a polysiloxane methacryloxypropyl terminated polydimethylsiloxane. This functionalised organosilicon monomer has a ceramic yield (including a TGA₈₅₀ ceramic yield) of no greater than 50%, and specifically has a ceramic yield (including a TGA₈₅₀ ceramic yield) of about 12%.

The first functionalised organosilicon monomer may be present in an amount of at least about 15%, 20%, 25%, 30% or at least about 35% by weight of the preceramic resin and up to an amount of about 98%, 95%, 90%, or about 80% by weight of the preceramic resin. The first functionalised organosilicon monomer may also be present in the preceramic resin in an amount of at least about 10%, 15%, 20%, 25% or at least about 30% by volume of the preceramic resin. The amount of the first functionalised organosilicon monomer may be not more than about 95%, 90%, 80%, 75% or not more than about 70% by volume of the preceramic resin. Any minimum and maximum can be combined without restriction. For example, the amount may be between 15% and 98% by weight of the preceramic resin, between 15% and 80% by weight of the composition etc. In embodiments with a first but not a second functionalised organosilicon monomer, the first functionalised organosilicon monomer may preferably be present in an amount of at least about 60 wt % to about 95 wt %, preferably between about 65 wt % to about 90 wt %, and more preferably between about 70 wt % to about 85 wt %, say between 75 wt % and 80 wt %.

### Second Organosilicon Monomer

In addition to the first functionalised organosilicon monomer, in certain preferred embodiments the preceramic resin comprises a second functionalised organosilicon monomer having a second ceramic yield which is greater than the first ceramic yield by at least 5%. That is, in certain preferred embodiments, the preceramic resin comprises a first functionalised organosilicon monomer having a first ceramic yield of no greater than 50% and a second functionalised organosilicon monomer having a second ceramic yield which is greater than the first ceramic yield by at least 5%. In reasons containing a first and second functionalised organosilicon monomer, ceramic particles may also be included.

The second functionalised organosilicon monomer may be selected from the group described above in respect of the first functionalised organosilicon monomer as described above for the first functionalised organosilicon monomer, so long as it has a second ceramic yield which is 5% or more greater than the first. Otherwise, the broad classes and functional groups from which the second functionalised organosilicon monomer will be selected, including the polymerisable functional groups, are as described above for the first functionalised organosilicon monomer. This includes in respect of the preferred features. Generally, a second ceramic yield which differs from the first will arise from a different chemical structure of the second functionalised organosilicon monomer to that of the first functionalised organosilicon monomer, whether that be by way of the backbone or polymerisable functional group.

That is, in preferred embodiments, the second functionalised organosilicon monomer has a structure of Formula 1, Formula 2, Formula 3, Formula 4, Formula 5, Formula 6, Formula 7 or Formula 8, or a polysilsesquioxane, polysilsesquicarbodiimide and a polysilsesquiazane as defined above, substituted with one or more polymerisable functional groups selected from a group, or a group containing a motif, selected from one or more of, an ester, amine, hydroxyl, epoxide, vinyl, allyl, ethynyl, thiol, glycidyl, isocyanurate, alkacrylate, cyano, cyanate and thiocyanate, and more preferably one or more of a vinyl, allyl, thiol and an acrylate, most preferably a thiol or an acrylate, with the proviso as to the ceramic yield difference.

In certain embodiments, a polysilsesquioxane, polysilsesquicarbodiimide or a polysilsesquiazane may be used to advantage as the second functionalised organosilicon monomer as they tend to result in larger pores during pyrolysis, even tending towards the macropore size range, thereby allowing liquids and gasses to escape before collapsing with high shrinkage.

The second functionalised organosilicon monomer may contain a polymerisable functional group that is different from, though complementary to, the polymerisable functional group of the first functionalised organosilicon monomer, such that under polymerising conditions the first and second polymerisable functional groups react, optionally with a crosslinking agent, and crosslink the monomers together. Alternatively, the second functionalised organosilicon monomer may contain a polymerisable functional group that is the same as the polymerisable functional group of the first functionalised organosilicon monomer, such that under polymerising conditions the first and second polymerisable functional groups react with each other, optionally by a crosslinking agent, to crosslink the monomers together.

Crosslinking agents containing crosslinker groups may be included in the preceramic resin. Crosslinking agents are generally chemical compounds which may be said to be functionalised in that they include at least two or more functional groups as described above in respect of, and complementary to, the polymerisable functional groups of any one or all of the functionalised organosilicon monomer(s) included in the preceramic resin. The functional groups of a crosslinking agent react with polymerisable functional groups of functionalised organosilicon monomer(s) resulting in a crosslinker group in the structure of the preceramic polymer. Example crosslinking agents include functionalised silane monomers or oligomers, diacrylates and dithiols among others. When present, a crosslinking agent having crosslinker groups will be selected based on the polymerisable functional groups of the functionalised organosilicon monomer(s). Crosslinking groups may therefore be selected from the polymerisable functional groups described above in respect of the first and second functionalised organosilicon monomers, including in preferred embodiments selected from one or more of a vinyl, allyl, thiol and an acrylate.

In preferred embodiments, the second functionalised organosilicon monomer contains a polymerisable functional group that is different from, though complementary to, the polymerisable functional group of the first functionalised organosilicon monomer, such that under polymerising conditions the first and second polymerisable functional groups react together in the absence of a crosslinker group. A preferred example includes the combination of thiol and acrylate functional groups which are photopolymerisable together.

The second functionalised organosilicon monomer may be characterisable by a high degree of polymerisation just like the first functionalised organosilicon monomer as described above, for the same reason and to the same advantage. Again, thiol-ene and thiol-acrylate chemistry is particularly preferred for providing a high degree of polymerisation. This means that in preferred embodiments when a second organosilicon monomer is included, the second functionalised organosilicon monomer contains a polymerisable functional group that is preferably an allyl, a vinyl, a thiol or an acrylate, and is more preferably a thiol or an acrylate. The polymerisable functional group is intended to be complementary to a corresponding functional group of the preferred first functionalised organosilicon monomer as applicable to thiol-ene and thiol-acrylate chemistry. That said, a degree of polymerisation of the second monomer that is lower than the first is also applicable. That is, in resins with a first and a second functionalised organosilicon monomer, the monomers may be present in stoichiometric amounts equating to high or even complete polymerisation (crosslinking of the polymerisable functional groups). That is, the first and second functionalised organosilicon monomers may be present in a 1:1 ratio in respect of the polymerisable functional groups. However, it has also been found that the second functionalised organosilicon monomer may be present in excess, for example such that the first and a second functionalised organosilicon monomers may be present in a 1:3 ratio or a 1:2 ratio, preferably from a 1:1 to 1:2 ratio, in respect of the polymerisable functional groups. This may assist to drive the polymerisation of the first functionalised organosilicon monomer to a high degree of polymerisation or complete polymerisation, and imbue on the preceramic resin more favourable rheological properties suited to 3D printing, as the case may be, while still resulting in a strong and dense PDC material by and avoiding breakdown in the integrity of the PDC material by virtue of the high degree of polymerisation of the first functionalised organosilicon monomer. Residual uncrosslinked second functionalised organosilicon monomer may then burn off during pyrolysis which may assist to obtain high shrinkage.

By a first functionalised organosilicon monomer having a “first ceramic yield” and a second functionalised organosilicon monomer having a “second ceramic yield” is meant as distinct from each other. That is, a first functionalised organosilicon monomer having a first ceramic yield is a monomer with a different ceramic yield to that of a second functionalised organosilicon monomer having a second ceramic yield. That difference is at least 5%, meaning that the second ceramic yield will be 5% or more greater than the first ceramic yield. For example, when the first ceramic yield is 15%, the second ceramic yield will be 20% or greater.

A second organosilicon monomer with second ceramic yield which is at least 5% greater than the first ceramic of the first organosilicon monomer gives rise to an advantage of the present invention. Without wishing to be limited by theory, it is thought that a combination of monomers having ceramic yields which differ by at least 5% or more leads to the formation of porosity during pyrolysis allowing a greater volume of liquids and gases to escape, which then collapses during pyrolysis providing high shrinkage. In particular, it is thought that this enables the formation of mesopores and macropores and (though to a lesser extent) micropores during pyrolysis. It is believed that organosilicon monomers with different ceramic yields by 5% or more undergo different degrees of linear and volumetric shrinkage during conversion to ceramic material under pyrolytic conditions which results in the formation of these pores during pyrolysis before collapsing with shrinkage. Generally speaking, this advantage is increased the greater the difference between the two ceramic yields. For example, using a preceramic resin comprising first and second organosilicon monomers with ceramic yields which differ by about 30% or more tends to result in greater porosity during pyrolysis, and greater shrinkage, as compared to a preceramic resin comprising first and second organosilicon monomers with ceramic yields which differ by less than 30%, and certainly as compared with ceramic yields which differ by less than 5% when porosity may not be formed at all.

The second ceramic yield is greater than the first by at least 5% which may be an amount of, for example, at least 5%, at least 10%, at least 15%, at least 20%, at least 25%, at least 30%, at least 35%, at least 40% or more, such as 41%, 42%, 43%, 44%, 45% or 50% or more. The second ceramic yield may also be greater than the first ceramic yield by as much as 55%, 60%, 70%, 80% or even 90%. In preferred embodiments, the second ceramic yield differs from the first ceramic yield by 10% or more, preferably 20% or more, preferably 30% or more and even 40% or more, which may be between, for example, 10% and 80%, 20% and 70% or 30% and 60% or any combination of upper and lower limits without limitation. In specific preferred embodiments, the second ceramic yield is greater than the first ceramic yield by about 40% to 50%, including 40%, 42%, 43%, 44%, 45%, 46%, 47%, 48% or 49%. This also applies when considering specifically the TGA₈₅₀ ceramic yields.

Accordingly, in preferred embodiments where the first functionalised organosilicon monomer has a first ceramic yield which is a very low ceramic yield of anywhere from 5% to 20%, the second functionalised organosilicon monomer may have a second ceramic yield which is greater by anywhere from 10% to 60% which gives a second ceramic yield of from 15% to 80%. Similarly, when the second functionalised organosilicon monomer has the preferred second ceramic yield which is greater than the first by anywhere from 40% to 50%, the second ceramic yield may be from 45% to 70%, within the medium to high ceramic yield range. Again, the TGA₈₅₀ ceramic yields are applicable.

It has been found that the combination of a first ceramic yield which is a very low ceramic yield and a second ceramic yield which is a medium ceramic yield gives the best results. Accordingly, in preferred embodiments where the first functionalised organosilicon monomer is a polysiloxane methacryloxypropyl terminated polydimethylsiloxane (12% ceramic yield, very low), the second functionalised organosilicon monomer is the polysiloxane (mercaptopropyl) methylsiloxane homopolymer. This second functionalised organosilicon monomer has a ceramic yield (including a TGA₈₅₀ ceramic yield) of 55%, which is a medium ceramic yield, which differs from the first ceramic yield by about 43%.

The amount of the second functionalised organosilicon monomer, when present in the preceramic resin, may be present in in an amount of at least about 15%, 20%, 25%, 30% or at least about 35% by weight of the preceramic resin and up to an amount of about 80%, 75%, 70%, or about 65% by weight of the preceramic resin. The second functionalised organosilicon monomer may also be present in the preceramic resin in an amount of at least about 5%, 10%, 15%, 20% or at least about 25% by volume of the preceramic resin. The amount of the second functionalised organosilicon monomer may be not more than about 75%, 70%, 65%, 60% or not more than about 55% by volume of the preceramic resin. Any minimum and maximum can be combined without restriction. For example, the amount may be between 15% and 80% by weight of the preceramic resin, between 15% and 65% by weight of the preceramic resin etc.

Together, when present, the first and a second functionalised organosilicon monomers may be present in a combined amount of at least about 30%, 40%, 50%, 60% or at least about 70% by weight of the preceramic resin and up to an amount of about 98%, 95%, 90%, or about 80% by weight of the preceramic resin. The first and second functionalised organosilicon monomers may also be present in the preceramic resin in an amount of at least about 10%, 15%, 20%, 25% or at least about 30% by volume of the preceramic resin. The amount of the first and second functionalised organosilicon monomer may be not more than about 95%, 90%, 80%, 75% or not more than about 70% by volume of the preceramic resin. Any minimum and maximum can be combined without restriction. For example, the amount may be between 30% and 98% by weight of the preceramic resin, between 30% and 80% by weight of the composition etc. In preferred embodiments the first and second functionalised organosilicon monomer may together be present in an amount of at least about 60 wt % to about 90 wt %, preferably between about 65 wt % to about 85 wt %, and more preferably between about 70 wt % to about 80 wt % of the preceramic resin.

### Ceramic Particles

In certain preferred embodiments, in addition to the first functionalised organosilicon monomer having a first ceramic yield of no greater than 50%, the preceramic resin comprises ceramic particles. In resins containing a first functionalised organosilicon monomer and ceramic particles, a second functionalised organosilicon monomer having a second ceramic yield which differs from the first ceramic yield by at least 5% may also be included.

The ceramic particles may be porous or nonporous. Ceramic particles may be used to advantage. Without wishing to be limited by theory, it is thought that porosity is formed during pyrolysis which allows a greater volume of liquids and gases to escape, providing high shrinkage. It is believed that porosity is formed as the organosilicon monomers undergo shrinkage during conversion to ceramic material while the ceramic particles do not, or at least shrink to a lesser extent, such that the ceramic particles act as a scaffold about which the organosilicon monomers shrink which creates pores. The advantage is increased with the use of porous ceramic particles which, having pre-existing porosity, introduce a greater porosity by pores of size that may not otherwise be present or formable during pyrolysis in such volume, and which, in conjunction with other pore sizes present during pyrolysis via other means as described herein, may result in the release of a greater volume of liquids and gases during pyrolysis to form a PDC material characterised by high shrinkage. With continued pyrolysis, the pores may then be made to collapse which may result in even higher shrinkage. For example, micropores may be introduced during pyrolysis by the use of microporous ceramic particles. Similarly, micropores and/or mesopores may be introduced during pyrolysis by the use of mesoporous ceramic particles. The use of ceramic particles may also result in a comparatively stronger and denser PDC material that is less prone to cracking or other breakdown in the integrity of the PDC material. This is particularly advantageous in the formation of silica PDC material and other PDC materials that do not contain carbon, as carbon is thought to assist to maintain PDC material integrity. The applicability of ceramic particles to obtaining high shrinkage PDC materials is also surprising, given that ceramic particles do not tend to undergo shrinkage during pyrolysis, at least not in high or even medium amounts. However, in the present invention it has been found that the capability of forming pores during pyrolysis may result in high shrinkage PDC materials even in the presence of ceramic particles.

The PDC materials are based on organosilicon monomers which form silicon-based ceramic materials following pyrolysis, so preferably the ceramic particles are also formed from a silicon ceramic material. Examples of silicon ceramic materials from which ceramic particles may be made include SiO₂, Si₃N₄, SiC, SiCN, SiCO, SiCNO, SiBCN, SiBCO, SiAlCN, and SiAlCO. These forms of ceramic particles may be described as silicon ceramic particles. In preferred embodiments, the ceramic particles are silica (SiO₂) particles.

The ceramic particles may be of any size fit for purpose. For example, particle sizes of up to 1 mm are useable with many 3D printing methods, while particle sizes of up to several millimetres are useable with many injection moulding methods. That said, smaller ceramic particles are preferred. This is because it is believed that the smaller particles provide better rheological properties (especially for 3D printing) while providing a high volumetric percentage distribution for more uniform structural support. Accordingly, in some embodiments, the ceramic particles are microparticles. By “microparticles” is meant a plurality of particles having a particle size falling between 1 μm and 1 mm. Preferably, the microparticles have a size falling between 1 μm and 500 μm, between 1 μm and 200 μm, between 1 μm and 100 μm, and between 1 μm and 50 μm. It is common for particulate materials to be supplied with a specified particle size range which usually reflects that at least a majority portion of those particles have a size within that range. This may be described as a particle size distribution. The particles may be predominantly within that particle size range (e.g. >95%, >99%) or entirely within the particle size range. In some embodiments, at least 90%, 95%, 98%, 99%, 99.5% and even 99.9% of the ceramic microparticles included in the resin have a size of between about 1 μm and 200 μm, between about 1 μm and 100 μm, or between about 1 μm and 50 μm. In other embodiments, the ceramic particles are nanoparticles. By “nanoparticles” is meant a plurality of particles having a particle size falling under 1 μm. Preferably, the nanoparticles have a size falling under 500 nm, under 200 nm and even under 100 nm. In preferred embodiments, at least 90%, 95%, 98%, 99%, 99.5% and even 99.9% of the ceramic nanoparticles included in the resin have a size of between about 1 nm to about 100 nm, preferably between about 1 nm and 50 nm, and more preferably between about 5 nm and 20 nm. In some embodiments, the ceramic particles include both microparticles and nanoparticles, in which case the preceramic resin may be said to comprise ceramic particles wherein a plurality of particles have a particle size falling under 1 mm. Preferably, the ceramic particles have a size falling under 500 μm, under 200 μm, under 100 μm, or under 50 μm. In preferred embodiments, at least 90%, 95%, 98%, 99%, 99.5% and even 99.9% of the ceramic particles included in the resin have a size of between about 1 nm and 1 mm, between about 1 nm and 500 μm, between about 1 nm and 200 μm, between about 1 nm and 100 μm, or between about 1 nm and 50 μm. Methods for determining particle size and particle size distribution are known in the art and include small angle X-ray scattering, dynamic light scattering and transmission electron microscopy. Preferably, the particles size distribution is determined using transmission electron microscopy (TEM).

When porous ceramic particles are used, the porous ceramic particles may contain pores of varying sizes, though in preferred embodiments the porous ceramic particles are microporous and/or mesoporous so as to provide micropores and mesopores, or a greater volume thereof, during pyrolysis. Porous ceramic particles are determinable as micro-, meso- and/or macroporous using for example BET surface analysis and/or mercury porosimetry, which are techniques known in the art.

When ceramic particles are present, they may be present in the preceramic resin in an amount of at least about 0.5%, 1%, 2%, 5%, 8% or 10%, 15% or at least about 20% by weight of the preceramic resin. When present, the amount of the ceramic particles is preferably not more than about 95%, 90%, 80%, 70%, 50%, or not more than about 30% by weight of the preceramic resin. The amount of the ceramic particles by weight of the preceramic resin may be influenced by the size and density of the particles and as such can be included in the preceramic resin on a volume basis, in which case the ceramic particles may be present in the preceramic resin in an amount of at least about 0.1%, 0.5%, 1%, 2%, 5%, 8% or at least about 10% by volume of the preceramic resin. The amount of the ceramic particles may be not more than about 98%, 95%, 90%, 80% or not more than about 70% by volume of the preceramic resin. Any minimum and maximum can be combined without restriction. For example, the amount may be between 0.5% and 95% by weight of the preceramic resin, between 0.5% and 30% by weight of the preceramic resin, between about 0.1% and 98% by volume of the preceramic resin or between 0.1% and 70% by volume of the preceramic resin. etc. In the case of nanoparticles for example, an amount of between about 2 wt % to about 35 wt %, preferably between about 5 wt % to about 30 wt %, more preferably between about 10 wt % to about 25 wt %, and especially 10 wt %, 20 wt % or 25 wt % of the preceramic resin, has been found to be applicable to the formation of high shrinkage PDC materials.

### Other Components

Various other components may be included in the resins of the present invention. This includes but is not limited to one or more of a porogen, free radical initiator, free radical inhibitor, photoblocker, 3D printing resolution agent, colour, surfactant, dispersants and an emulsifier. These components are generally known in the art.

A “porogen” is an organic compound which when added to a preceramic resin is capable of escaping during pyrolysis of a preceramic polymer in the process of forming a PDC material.

A porogen may be used to advantage. Without wishing to be limited by theory, it is thought that a porogen escapes as gases during pyrolysis and, in escaping, leaves behind pores which allows other gasses and liquids to escape before collapsing with shrinkage. The size of the pores introduced by a porogen during pyrolysis depend on the size of the porogen itself, though are typically mesopores and/or macropores. That is, a meso porogen will tend to result in mesopores (and may also result in micropores) while a macro porogen will tend to result in macropores (and may also result in mesopores). Similarly, a combination of a meso porogen and a macro porogen will tend to result in a combination of mesopores and macropores.

Examples of preferred meso porogens include toluene, methanol, cyclohexanol, hexane, dodecanol, 1,2-popanediol, water, 1-propanol, 1,4-butandiol, dimethylformamide, acetonitrile, decane and decanol, while example of preferred macro porogens include polyethylene glycol (PEG) such as PEG 200, PEG 400, and PEG 20,000, and polyethylene glycol diacrylate (PEGDA) such as PEGDA 250 and PEGDA 575. In preferred embodiments the meso porogen is toluene and the macro porogen is PEG 400.

When present, a porogen may be present in an amount of between about 1 wt % to about 50 wt %, preferably between about 2 wt % to about 20 wt %, and more preferably between about 5 wt % to about 15 wt % of the preceramic resin.

As explained above, because the resins of the invention find particular utility in forming shaped preceramic polymer and PDC articles using 3D printing and injection moulding processes, the polymerisable functional group of the organosilicon monomer(s) is preferably so-compatible and as such in many embodiments is thermal- or photopolymerisable. In which case, the resin may further comprise a free radical generator such as a thermal initiator or photoinitiator which in many instances form free radicals which catalyse the reaction of thermal- or photopolymerisable functional groups, respectively. When present, the thermal or photoinitiator may be present in an amount of between about 0.01 wt % to about 20 wt %, preferably between about 0.1 wt % to about 5 wt %, and more preferably between about 0.2 wt % to about 1 wt % of the preceramic resin.

Examples of thermal initiators include benzoyl peroxide, dicumyl peroxide and 2,2′-azobisisobutyronitrile.

Examples of photoinitiators include 2,2-dimethoxy-2-phenylacetophenone, 2-hydroxy-2-methylpropiophenone, camphorquinone, phenylbis (2,4,6-trimethylbenzoyl) phosphine oxide (BAPO), benzophenone and benzoyl peroxide. In preferred embodiments the photoinitiator is BAPO.

Examples of photoblockers include 2,5-Bis(5-tert-butyl-benzoxazol-2-yl)thiophene (BBOT), 4,4′-bis(benzoxazolyl)-cis-stilbene and 4,4-diamino-2,2-stilbenedisulfonic acid. In preferred embodiments the photoblocker is BBOT.

In preferred embodiments, for example in which the polymerisable function groups of the functionalised organosilicon monomer(s) are acrylate and thiol groups, the free radical generator is a photoinitiator which forms free radicals under UV light (wavelength of about 100 to about 405 nm). The preferred example is phenylbis (2,4,6-trimethylbenzoyl) phosphine oxide.

The resin may also further comprise a free radical inhibitor (also known as free radical scavenger). Examples include hydroquinone, methylhydroquinone, ethylhydroquinone, methoxyhydroquinone, ethoxyhydroquinone, monomethylether hydroquinone, propylhydroquinone, propoxyhydroquinone, tert-butylhydroquinone (TBHQ) and n-butylhydroquinone. In preferred embodiments the free radical inhibitor is tert-butylhydroquinone. When present, the free radical inhibitor may be present in an amount of about 0.01 wt % to about 20 wt %, preferably between about 0.05 wt % to about 5 wt %, and more preferably between about 0.1 wt % to about 2 wt % of the preceramic resin.

When a photoblocker is included, the preferred photoblocker is 2,5-Bis(5-tert-butyl-benzoxazol-2-yl)thiophene (BBOT). When present, a photoblocker may be present in an amount of between about 0.01 wt % to about 20 wt %, preferably between about 0.1 wt % to about 5 wt %, and more preferably between about 0.2 wt % to about 1 wt % of the preceramic resin.

Another component that may be included in the resins of the present invention is a third and subsequent functionalised organosilicon monomer. The third and subsequent functionalised organosilicon monomer may be selected in the same way and having the same identity and polymerisable functional groups as the first and second functionalised organosilicon monomers described above. The polymerisable functional groups of the third functionalised organosilicon monomer are selected for reactivity, optionally via a crosslinker group, with one or more of the polymerisable functional groups of the first and/or second functionalised organosilicon monomers. It is not necessary that the third and subsequent functionalised organosilicon monomer has a different ceramic yield to the first and/or second. However, if it does have a (third) ceramic yield that is different to the first and second ceramic yields, this may further contribute to the formation of pores during pyrolysis adding to the advantages herein described.

When present, the third and subsequent functionalised organosilicon monomer is preferably a polysiloxane, a polysilsesquioxane, a polycarbosilane or a polycarbosilazane. The third (or subsequent) functionalised organosilicon monomer may be selected from one or more of methacryloxypropyl terminated polydimethylsiloxane, vinylmethoxysiloxane homopolymer, methacryloxypropyl substituted poly(isobutyl-t8-silsesquioxane), allylhydrydopolycarbosilane and methylvinylhydrogen polycarbosilazane. When present, the third and subsequent functionalised organosilicon monomer may be present in an amount of about 1 wt % to about 50 wt %, preferably between about 5 wt % to about 30 wt %, and more preferably between about 10 wt % to about 20 wt % of the preceramic resin.

Another component that may be included in the resins of the present invention is a functionalised organic monomer.

An “organic monomer” is a carbon-containing chemical compound and is other than the organosilicon monomers as described herein. The organic monomer is typically a silicon-free organic monomer. Organic compounds tend to contain covalent carbon-carbon bonds and carbon-hydrogen bonds, and often contain covalently-bonded heteroatoms such as oxygen and nitrogen. Organic compounds are identifiable to those of skill in the art. A “functionalised” organic monomer is one which contains two or more reactive functional groups each of which are reactive with at least the first functionalised organosilicon monomer to form crosslinks. This may be by crosslinking with the organosilicon monomer functional groups. The functional groups of the functionalised organic monomer may thus be referred to as polymerisable functional groups. The portion of chemical structure between the reactive groups may be referred to as a “spacer”. A functionalised organic monomer may thus be represented by the following formula:

Spacer(L)ₙ
wherein Spacer is a spacer group, L is a reactive group reactive with at least the first functionalised organosilicon monomer, and n is an integer of greater than or equal to 2. In preferred embodiments, n is an integer of from 2 to 4, and is preferably 2.

The spacer group may be based on a short- or long-chain, optionally branched, backbone structure including for example ethylene, ethylene glycol, polyethylene, polyethylene glycol propylene, polypropylene glycol, polypropylene, polyproypylene glycol, ethylamine, polyethyleneimine, propylamine, polypropyleneimine etc. By “substituted” in reference to an organic monomer is meant that any one or more atoms or chemical groups pendant to an atom of the backbone chain is replaced, provided that the atom's valence is not exceeded and a stable compound results. The reactive group may be substituted at any point(s) of the backbone chain, and are preferably terminally substituted, i.e. at two end groups of the backbone structure. The at least two reactive groups may be the same or different depending on the desired crosslinking with the first and second functionalised organosilicon monomer. The two or more reactive groups are preferably the same. The reactive group is preferably selected from a group, or a group containing a motif, selected from one or more of an ester, amine, hydroxyl, epoxide, vinyl, allyl, ethynyl, thiol, glycidyl, isocyanurate, alkacrylate, cyano, cyanate and thiocyanate. In preferred embodiments, the reactive group is an allyl, a vinyl, a thiol or an acrylate.

Representative preferred functionalised organic monomers include ethylene glycol diacrylate, poly ethylene glycol diacrylate, ethylene glycol dithiol, polyethylene glycol dithiol, ethylene glycol divinyl ether, polyethylene glycol divinyl ether, ethylene glycol diallyl ether, and polyethylene glycol diallyl ether.

The crosslinking agents described above may also constitute functionalised organic monomers.

An advantage of the use of a functionalised organic monomer is that they tend to be more reactive under polymerising conditions than functionalised organosilicon monomers and can assist to increase the rate of polymerisation and extent of crosslinking and assist to give rise to porosity formed in the polymer-derived ceramic material at appropriate pyrolytic condition temperatures.

When present, the functionalised organic monomer is included in stoichiometric amounts equating to complete, or as near as possible complete, reactivity of the polymerisable functional groups of the first and second functionalised organosilicon monomers. Within this preferred parameter, the amount of the functionalised organic monomer, when present in the preceramic resin, may be present in in an amount of at least about 1%, 2%, 5%, 8% or 10%, 15%, 20%, 25%, 30% or at least about 35% by weight of the preceramic resin and up to an amount of about 80%, 75%, 70%, or about 65% by weight of the preceramic resin. Any minimum and maximum can be combined without restriction. For example, the amount may be between 1% and 80% by weight of the preceramic resin, between 15% and 65% by weight of the composition etc.

### Methods of the Invention

Methods of the present invention involve subjecting a preceramic resin to polymerising conditions to form a preceramic polymer, and pyrolysing the preceramic polymer to form a PDC material.

“Polymerising conditions” are conditions under which polymerisation reactions occur. A number of polymerisation reaction chemistries are applicable including but not limited to step-growth polymerisation including condensation reactions, and chain-growth polymerisation including cationic or anionic addition reactions or thermal- or photo-catalysed free radical reactions. The polymerising conditions selected will depend on the polymerisable functional groups of the functionalised organosilicon monomer(s) and are intended to crosslink the monomers together.

In preferred embodiments, the components of the preceramic resins are such that they are capable of resulting in pores being contained in the material during pyrolysis. Such preceramic resins are as described herein. In most preferred embodiments, the preceramic resin is as herein described in its preferred embodiments.

As described above, the resins of the invention find particular utility in forming shaped preceramic polymer and PDC material articles using 3D printing and injection moulding processes, and so the polymerisable functional groups are so-compatible, preferably being photopolymerisable. Thus, in preferred embodiments the polymerising conditions include the presence of other components in the preceramic resin which aid photopolymerisation, as described above.

“Pyrolysis” is the thermally-induced conversion of the preceramic polymer from organic to inorganic (i.e. PDC) material. Similarly, “pyrolytic conditions” are conditions including elevated temperatures under which pyrolysis occurs. During pyrolysis, the inorganic material formed may exist in one or more material phases depending on the temperature to which the material is exposed; for example the inorganic material may proceed through an amorphous phase and then, as the temperature increases, transitions to a crystalline phase. Similarly, when the preceramic resin contains components that contain pores (e.g. porous ceramic particles) or are capable of forming pores during pyrolysis (e.g. preceramic resins as described herein), the amorphous phase may encompass a “porous phase” and a “non-porous phase”. The porous phase is characterised by the containing of pores, while the non-porous phase is other than the porous phase. The non-porous phase occurs at higher temperatures than the porous phase, arising from the collapse of pores present in the porous phase. The temperature at which the porous phase ceases to exist and the non-porous phase comes into being may be referred to as the “porosity transition temperature”.

The temperatures range across which the porous and non-porous phases exist may differ depending on the composition of the preceramic resins. Generally speaking, the greater the number of components in a preceramic resin the higher the porosity transition temperature tends to be. For instance, a preceramic resin comprising a first functionalised organosilicon monomer, a second functionalised organosilicon resin, ceramic particles, a photoinitiator, free radical generator and a photoblocker may present with a higher porosity transition temperature than a preceramic resin not having one of these components; for example a preceramic resin comprising a first functionalised organosilicon monomer, a second functionalised organosilicon resin, a photoinitiator, free radical generator and a photoblocker (i.e. absent of ceramic particles). In embodiments containing a greater number of components, the porosity transition temperature may be, for example, as high as about 1100° C. That said, generally speaking the porous phase may occur within the range of about 300° C. and 1000° C. and often within the range of about 300° C. and 900° C. For instance, in embodiments in which the porous phase ceases to exist at 900° C., then 900° C. is taken to be the porosity transition temperature. Whether or not a PDC material has been formed by pyrolysis with a maximum temperature of below the porosity transition temperature, or within the porous phase, is determinable by measuring the porosity of the formed material, for example using BET surface analysis as described herein. The porosity transition temperature is similarly determinable by, for example, analysing the porosity of PDC materials formed at different temperatures. Accordingly, porous and non-porous PDC materials may be produced by controlling the temperature of pyrolysis; a porous PDC material may be produced by not exceeding the porosity transition temperature, while a non-porous PDC material may be produced by exceeding the porosity transition temperature.

### Pyrolytic Conditions for Non-Porous PDC Materials

Accordingly, for producing non-porous PDC materials, the pyrolytic conditions of the methods of the present invention comprise a minimum temperature (i.e. the minimum temperature that must be reached during pyrolysis) of no less than the porosity transition temperature. In preferred embodiments, the minimum temperature is at least about 900° C. By “minimum temperature” is meant that the temperature during pyrolysis is increased to a value that rises above the given “minimum temperature”.

This high minimum temperature is utilised to induce the necessary organic to inorganic conversion of the preceramic polymers to form PDC materials and also to result in the collapse of pores during pyrolysis to result in high shrinkage PDC materials. Temperatures higher still are applicable, for example towards transition from amorphous to crystalline phases, and in preferred embodiments the temperature reached during pyrolysis is a minimum of at least 950° C., 1000° C., 1050° C., 1100° C., 1150° C., 1200° C. or 1250° C. This minimum temperature may also be coupled with a maximum temperature of pyrolysis, which may in preferred embodiments be not more than 1600° C. By “maximum temperature” is meant that the maximum temperature reached during pyrolysis does not exceed the given “maximum temperature” value. Reaching a temperature during pyrolysis of at least 900° C. but not higher than 1600° C. is preferred because it results in pore collapse and shrinkage while avoiding higher temperatures at which the PDC material may start to approach its melting point. Lower maximum temperatures are applicable for the same result and more preferred, including 1550° C., 1500° C., 1450° C., 1400° C. or 1350° C. Accordingly, expressed as a range, in preferred embodiments, for forming non-porous PDC materials, pyrolysis is performed so as to reach a temperature of between 900° C. and 1600° C., 1000° C. and 1550° C., preferably 1050° C. and 1500° C., 1100° C. and 1450° C., and more preferably 1150° C. and 1400° C. or 1200° C. and 1350° C. Most preferably, pyrolysis is performed at about 1300° C.

### Pyrolytic Conditions for Porous PDC Materials

For producing porous PDC materials, the pyrolytic conditions of the methods of the present invention are characterised by a maximum temperature of less than the porosity transition temperature. In preferred embodiments, the maximum temperature is less than about 900° C.

This maximum temperature is utilised to induce the necessary organic to inorganic conversion of the preceramic polymers to form PDC materials but also to retain porosity in the PDC material; i.e. to retain at least a portion of the pores formed or otherwise present, during pyrolysis. This may be assisted with a maximum temperature that is lower still, and in preferred embodiments the maximum temperature is 850° C., 800° C., 750° C. or 700° C. including 650° C. and even 600° C. This maximum temperature may also be coupled with a minimum temperature of pyrolysis, which may in preferred embodiments be as low as about 300° C. This minimum temperature is preferred for efficient conversion of organic to inorganic material. Higher minimum temperatures are applicable for the same result and preferred, including 325° C., 350° C., 375° C. 400° C. 425° C. or 500° C. Expressed as a range, in preferred embodiments pyrolysis is performed at a temperature of between 300° C. and 900° C., 325° C. and 850° C., preferably 350° C. and 800° C., 375° C. and 750° C., and more preferably 400° C. and 700° C., and in some embodiments, 425° C. and 650° C. or 450° C. and 600° C. Most preferably, for forming porous PDC materials, pyrolysis is performed at a maximum of between about 600° C. and 700° C.

### Pyrolytic Conditions

For producing both porous and non-porous PDC materials, the pyrolytic conditions of the methods of the present invention may be characterised by a temperature ramp-up rate of no greater than 10° C./minute for a period within the porous phase. This ramp-up rate of no greater than 10° C./minute (or even slower as described below) is referred to as a “slow ramp-up rate”. The temperature ramp-up (i.e. increase) rate of no greater than 10° C./minute for a period within the porous phase is used to advantage. Previously, relatively fast temperature ramp-up rates of greater than 10° C./minute have been used during pyrolysis. In the present invention, and without wishing to be bound by theory, it is thought that using a slower ramp-up rate of no greater than 10° C./minute allows, using preceramic resins capable of forming pores during pyrolysis, for the slower formation of pores of different sizes and a greater extent of porosity during pyrolysis. It is also though that the slow ramp-up rate allows for a longer time period during which pores are present from which liquids and gases can escape to provide high shrinkage, including shrinkage at temperatures over the porosity transition temperature when the pores have collapsed. It may also slow the rate at which liquids and gases are formed and diffuse from the material, reducing the risk of pressure build-up and cracking or other breakdown in the PDC material integrity.

This advantage is increased with even slower ramp-up rates than 10° C./minute and for specific periods within the temperature range of the porous phase. Accordingly, in preferred embodiments, the temperature ramp-rate is no greater than 7° C./minute, preferably no greater than 5° C./minute, preferably no greater than 3° C./minute, more preferably no greater than 2° C./minute and most preferably no greater than 1° C./minute. In certain preferred embodiments, it may be even slower, being no greater than 0.5° C./minute or even 0.3° C./minute. In other words, and expressed as a range, the temperature ramp-up rate may preferably be, within the temperature range of the porous phase, between 0.1° C./min and 10° C./min, between 0.1° C./min and 7° C./min, between 0.1° C./min and 5° C./min, between 0.2° C./min and 3° C./min, between 0.2° C./min and 2° C./min and preferably between 0.3° C./min and 1° C./min. In certain embodiments the ramp-up rate may be specifically about 0.3° C./min or about 1° C./min within the temperature range of the porous phase.

The slow ramp-up rate may be used for the entire period within the temperature range of the porous phase or may be used for a portion of the period within the temperature range of the porous phase. In some embodiments, the slow temperature ramp-up rate is used at least until the conversion temperature. The “conversion temperature” is the temperature at which the preceramic polymer has converted to PDC material. In other words, in preferred embodiments, the pyrolytic conditions of the methods of the present invention are characterised by a temperature ramp-up rate of no greater than 10° C./minute, and preferably slower as described herein, for a period within the temperature range of 100° C. to at least the conversion temperature. The conversion temperature will differ slightly with different resins and their components but is generally at around 500° C. to 650° C. or 700° C. with some material at times beginning to covert at around 300° C., in which case in preferred embodiments the slow ramp-up rate is used for a period within the temperature range of 100° C. to at least about 500° C. to 650° C. or 700° C. Similarly, in some embodiments, the slow temperature ramp-up rate is used at least from about the pore formation temperature (pre-existing pores from the use of porous ceramic particles notwithstanding). The “pore formation temperature” is the temperature at which pores begin to form during pyrolysis, which generally occurs just after the preceramic polymer has thermally cured, which often occurs between about 100° C. and 300° C. In other words, in preferred embodiments, the pyrolytic conditions of the methods of the present invention are characterised by a temperature ramp-up rate of no greater than 10° C./minute, and preferably slower as described herein, for a period within the temperature range of the pore formation temperature to at least the conversion temperature. The pore-formation temperature will differ slightly with different resins and their components but is generally at around 200° C. to 300° C., in which case in preferred embodiments the slow ramp-up rate is used for a period within the temperature range of at least of about 200° C. to 700° C., or otherwise to the maximum pyrolysis temperature.

Accordingly, for producing both porous and non-porous PDC materials, the pyrolytic conditions of the methods of the present invention may be characterised by a ramp-up (i.e. increase) rate of no greater than 10° C./minute for a period within the temperature range of 100 to 900° C., which may be a period within the temperature range of about 100° C. to 700° C., 200° C. to 700° C., about 200° C. to 600° C., about 300° C. to 700° C. or about 300° C. to 600° C.

Preferably, even slower ramp-up rates than 10° C./minute are used, and for specific periods within the temperature range of 100 to 900° C. Accordingly, in preferred embodiments, the temperature ramp-rate is no greater than 7° C./minute, preferably 5° C./minute, preferably no greater than 3° C./minute, more preferably no greater than 2° C./minute and most preferably no greater than 1° C./minute. In certain preferred embodiments, it may be even slower, being no greater than 0.5° C./minute or even 0.3° C./minute. In other words, and expressed as a range, the temperature ramp-up rate may preferably be, within the temperature range of 100 to 900° C., between 0.1° C./min and 10° C./min, between 0.1° C./min and 7° C./min, between 0.1° C./min and 5° C./min, between 0.2° C./min and 3° C./min, between 0.2° C./min and 2° C./min and preferably between 0.3° C./min and 1° C./min. In certain embodiments the ramp-up rate may be specifically about 0.3° C./min or about 1° C./min.

The slow ramp-up rate may be used for the entire period within the temperature range of 100 to 900° C. or may also be used for a portion of the period within the temperature range of 100 to 900° C. For example, the slow ramp-up rate may be used for the entire period across the temperature range of about 100° C. to 700° C., about 100° C. to 600° C., about 200° C. to 700° C., about 200° C. to 600° C., about 300° C. to 700° C. or about 300° C. to 600° C. In preferred embodiments, the slow temperature ramp-up rate is used at least from about the pore formation temperature (pre-existing pores from the use of porous ceramic particles notwithstanding) to at least until the conversion temperature. In other words, in preferred embodiments, the pyrolytic conditions of the methods of the present invention are characterised by a temperature ramp-up rate of no greater than 10° C./minute, and preferably slower as described herein, for a period within the temperature range of the pore formation temperature to 900° C., or to at least the conversion temperature. In preferred embodiments the slow ramp-up rate is used for a period within the temperature range of 100° C. to 900° C. or at least of about 200° C. to 600° C. That is, the slow ramp-up rate (i.e. less than 10° C./minute, or a lesser value as discussed above) is preferably maintained across the time period during which the temperature progresses from about 200° C. to 600° C.

The duration of the slow ramp-up rate may additionally or alternatively be expressed by reference to a time period. The duration of the period in which the slow ramp-up is used may differ depending on the ramp-up rate used, the pore formation temperature and the maximum pyrolysis temperature. In preferred embodiments, the duration of the period in which the slow ramp-up is used at least 30 minutes, and preferably at least 1 hour. The period may be longer, for example at least 1.5 hours, 2 hours, 3 hours, 5 hours, 10 hours, 15 hours, 20 hours or longer. The time period may be up to 40 hours, 45 hours, 50 hours or 55 hours. Expressed as a range, the slow ramp-up rate may be used for a duration of from 1 hour to 55 hours, or 1.5 hours to 50 hours, or 2 hours to 45 hours, or 3 hours to 40 hours, or 15 hours to 40 hours, for example 20 to 25 hours. In preferred embodiments where the slow temperature ramp-up rate is used for the entire period within the temperature range of 100° C. to at least the conversion temperature, and where the conversion temperature is for example 650° C., the duration of the period may be about 55 minutes (using a ramp-up rate of 10° C./minute), about 1 hour 19 minutes (using a ramp-up rate of 7° C./minute), 1 hours 50 minutes (using a ramp-up rate of 5° C./minute), 3 hours 3 minutes (using a ramp-up rate of 3° C./minute), 4 hours 35 minutes (using a ramp-up rate of 2° C./minute), 9 hours 10 minutes (using a ramp-up rate of 1° C./minute), 18 hours 20 minutes (using a ramp-up rate of 0.5° C./minute) and 30 hours 33 minutes (using a ramp-up rate of 0.3° C./minute).

The slow ramp-up rate may also be used in periods of higher temperatures including to the maximum pyrolysis temperature as described above, and as applicable. That is, while the slow ramp-up rate of no greater than 10° C./minute, and preferably slower as described herein, is used for a period within the temperature range of 100 to 900° C., the slow ramp-up rate may also be used above 900° C., for example to 950° C., 1000° C., 1050° C., 1100° C., 1150° C., 1200° C., 1250° C. or 1300° C., or to the maximum pyrolysis temperature, or for any period within the range of 900° C. to the maximum pyrolysis temperature.

Pyrolysis may be performed in an inert or a reactive atmosphere. A reactive atmosphere is generally characterised by the presence of a reactive gas; that is, a gas that is, under pyrolytic conditions, reactive to at least one component of the preceramic polymer material. An inert atmosphere is generally characterised by the absence of a reactive gas. Examples of reactive gases include oxygen, carbon dioxide, water (e.g. water vapour), methane, iodine, and ammonia. Air is an example of a reactive gas that contains oxygen, carbon dioxide and potentially water. An example of an inert environment is an environment of nitrogen gas or under vacuum.

The pyrolysis conditions may also include a hold time, in which the temperature is held at a specific temperature for a period of time. Examples of applicable points to use a hold time include at about the pore formation temperature, the conversion temperature, at the maximum pyrolysis temperature and at the collapse temperature. By “collapse temperature” is meant the temperature at which pores present in the material during pyrolysis begin to collapse. The collapse temperature will differ slightly with different resins and their components but is generally at about 700° C. to 1100° C. in which case a hold time may be used at a temperature within the range of about 700° C. to about 1000° C., and usually about 1000° C.

A hold time may be used to advantage. Without wishing to be bound by theory, it is thought that using a hold time the chemical process under way at any given pyrolysis temperature may be urged towards completion. For example, a hold time at a temperature of about the conversion temperature may assist to achieve towards complete conversion of preceramic polymer to PDC material while retaining porous structure present, and allowing liquids and gases to escape, a hold time at a temperature of about the collapse temperature may assist to achieve complete collapse of pores with high shrinkage, while a hold time at the maximum pyrolysis temperature may assist to achieve complete conversion of preceramic polymer to a strong and dense PDC material.

Accordingly, in preferred embodiments, the pyrolytic conditions are characterised by a hold time of one or more of about the conversion temperature, about the maximum pyrolysis temperature and about the collapse temperature.

The period of the hold time at any given temperature may be, for example, between 30 and 300 minutes, or between 60 and 240 minutes, and preferably between 60 and 180 minutes. The period of the hold time may differ at different hold time temperatures. For example, the period of the hold time at the conversion temperature may be comparatively long to maximise the advantage of assisting towards complete conversion of preceramic polymer to PDC material while retaining porous structure present and allowing liquids and gases to escape. The period of the hold time at the conversion temperature is preferably about 180 minutes. The period of the hold time at the collapse temperature and at the maximum pyrolysis temperature may be comparatively shorter, and are preferably about 60 minutes each, when used.

Methods of pyrolysis are otherwise known to persons skilled in the art. Generally speaking, a preceramic polymer material is placed in a cool furnace and the temperature is ramped up towards maximum and ramped down again at a specified rate(s). For example, while ramp-up has been discussed, ramp down rates may be selected based on the thermogravimetric profile of the organosilicon monomers used, as known to the person skilled in the art. In preferred embodiments, ramp down rates are similarly controlled as described herein for ramp up rates, being generally of no greater than 10° C./min, and may be slower for specific periods, for example between about 0.5° C./min and 1° C./min or 2° C./min.

The total time period of pyrolysis, from room temperature to a return to room temperature, may occupy several hours. This is in contrast to previous processes for the pyrolytic conversion of a green body to a PDC material, which have tended to use fast ramp up and ramp down rates and short, if any, hold times. Generally speaking, the preferred conditions as described herein for forming the PDC materials are much more gentle and achieve controlled formation of the material with high shrinkage.

### PDC Materials Formed

The particular PDC material produced will arise from the identity of the functionalised organosilicon monomer(s) and the selected ceramic particles (if present), and as such depends on the composition of the preceramic resin. Using organosilicon monomers, silicon-based PDC materials are produced. PDC materials which may be produced depending on the preceramic polymer composition and pyrolytic conditions include SiO, Si₃N₄, SiC, SiCN, SiCO, SiCNO, SiBCN, SiBCO, SiAlCN, SiAlCO, SiON and/or SiBN.

The particular PDC material produced may also depend on certain parameters of the pyrolytic conditions used. For instance, the presence of a reactive environment will generally influence the nature of the gases which escape from the material during pyrolysis and thus the nature of the PDC material produced. For example, pyrolysis of a preceramic polymer formed from a polysiloxane organosilicon monomer in an inert atmosphere will generally produce silicon oxycarbide ceramic material. Whereas, pyrolysis of a preceramic polymer formed from a polysiloxane organosilicon monomer in a reactive air environment produces silica ceramic material. This is because the gases in air (e.g. O₂) undergo reactions with carbon atoms in the organosilicon backbone structure of the polysiloxane and escape as carbon-containing gases. The principle finding of formation of silica PDC materials is described in the specification for Australian patent application number 2022900557 which is herein incorporated by reference in its entirety.

In conjunction, the maximum temperature used during pyrolysis may also influence the nature of the PDC material produced. For example, pyrolysis of a preceramic polymer formed from an organosilicon monomer in an inert atmosphere using a maximum pyrolysis temperature of, within the non-porous phase temperature range, less than the crystallisation temperature, may produce glass-ceramic material by inducing a phase-separation of PDC materials. By the “crystallisation temperature” is meant the temperature at which the pyrolysed silicon-based PDC material converts from an amorphous phase into a crystalline phase. In particular, pyrolysis of a preceramic polymer formed from polysiloxane organosilicon monomers in an inert atmosphere using a maximum pyrolysis temperature of less than the crystallisation temperature, but within the non-porous phase temperature range, may produce silicon oxycarbide glass-ceramic material. In particular, this may produce glass containing interspersed free carbon in crystalline form. Accordingly, in some embodiments, the PDC material making up the glass portion of the glass-ceramic material is silica, while the PDC material making up the ceramic portion of the glass-ceramic material is crystalline carbon. Thus, in some embodiments, the glass-ceramic material is silicon oxycarbide.

Glass-ceramic materials offer unique chemical and mechanical properties, such as significant chemical inertness, oxidative resistance, creep resistance, crystallisation resistance, increased young's modulus, hardness, and glass transition temperatures, and often better than glass and ceramic materials themselves, so it is to particular advantage that glass-ceramic materials are provided by the present disclosure.

The crystallisation temperature will differ slightly with different resins and their components but is generally at above 1200° C. For example, the crystallisation temperature may be within the range of 1200° C. to 1400° C. In some embodiments, the maximum pyrolysis temperature for forming glass-ceramic PDC materials is within the range of 1200° C. to 1400° C., preferably 1250° C. to 1350° C., for example around 1300° C. As the temperature is generally within the non-porous phase, then the minimum pyrolysis temperature for forming glass-ceramic PDC materials is accordingly 900° C., preferably 1000° C. and more preferably 1100° C.

Previous methods for making glass-ceramic materials generally require very high temperatures and the materials are prone to cracking or other breakdown in the integrity of a manufactured article, especially when dense ceramic structures are attempted to be formed. The glass-ceramic PDC structures provided herein do not require as-high temperatures and are less prone to cracking and other breakdown during manufacture by the methods described herein, even though the preceramic resins used herein tend to form dense ceramic and glass-ceramic structures. It is to advantage that dense glass-ceramic structures are provided by the present disclosure.

Within the non-porous phase, it is not as critical to use a temperature ramp-up that is slow (in contrast to the porous phase as described above), though slow ramp-up rates are advantageous. In preferred embodiments, the temperature ramp-rate during the non-porous phase is no greater than 15° C./minute, preferably 10° C./minute, preferably no greater than 8° C./minute, more preferably no greater than 7° C./minute. In some embodiments, slow ramp-up rates of, for example, 5, 3, 2 1, 0.5 and 0.3° C./minute may be used. Expressed as a range, the temperature ramp-up rate within the temperature range of the non-porous phase may be between 3° C./min and 15° C./min or between 5° C./min and 8° C./min. In certain embodiments the ramp-up rate may be specifically about about 7° C./min.

### EXAMPLES

The TGA₈₅₀ method for determining ceramic yield of organosilicon monomers is as follows.

A known amount of a functionalised organosilicon monomer (preferably between 10 mg and 20 mg) was transferred to an alumina crucible approved for the thermogravimetric analyser in use. The crucible was placed in the analyser and its weight change with respect to time and temperature was studied as per the manufacturers' instructions. The sample crucible was subjected to a thermal cycle under nitrogen from room temperature to 850° C. and then back to room temperature. The sample was equilibrated at 30° C. for 30 minutes, and the resulting weight was tarred before increasing the temperature from 30° C. to 850° C. at a ramp rate of 1° C./minute. The sample was further equilibrated at 850° C. for 60 minutes before cooling down from 850° C. to room temperature at a rate of 5° C./min. The percentage change in weight of the sample during this thermal cycle is used to calculate the ceramic yield, where the percentage ceramic yield is calculated as (1−sample weight lost/initial sample weight)*100.

A real-time Fourier-transform infrared (RT-FTIR) spectroscopy method was developed to study the photo-polymerisation reaction kinetics, relevant to a number of the Examples presented below. The setup for the kinetic study is shown schematically in FIG. 12. All RT-FTIR measurements were collected on a Fourier-transform infrared spectrometer in the range of 4000-600 cm⁻¹. OPUS software equipped with an atmospheric compensation and extended ATR correction was used to analyse the data. A monochromatic UV LED with a 3 mm focusing lens (with λmax=405 nm and intensity of 20 mW/cm²) was used for irradiating all samples. A basic electrical circuit was employed to power the LED, while monitoring the current to prevent any damage. A LED cover was custom designed, and 3D printed to align the LED with the sample and to avoid samples being exposed to ambient light before experiments. The LED was positioned 3 mm above the ATR stage. The samples were exposed to the air during the reaction monitoring to consider the impact of oxygen inhibition on the photo-polymerisation kinetics. All experiments were performed at room temperature and under atmospheric conditions.

The —CH═CH₂ bending and stretching peaks at ˜939 cm⁻¹ and ˜1637 cm⁻¹ were monitored to calculate the gelation time and percentage polymerisation, respectively. The gelation point can be defined as the time at which cross-linking takes place, after which the photo-polymerisation reaction can still proceed. To determine thiol conversion, the height of the —CH═CH₂ bending peak centred at 939 cm⁻¹ was monitored over time as per Equation (1), where Xₜ is thiol conversion at time (t), A₀ is the initial absorbance, and Aₜ is the absorbance at the time (t).

The peak area at ˜1637 cm⁻¹ in the range of 1650-1620 cm⁻¹ was integrated at a subsequent time (t), and the percentage of polymerisation (%) at that time was calculated as per Equation (2), where Pₜ is the percentage polymerisation at time (t), A₀ is the initial absorbance, and Aₜ is the absorbance at the time (t).

$${X}_{t} = \frac{{A}_{0} - {A}_{t}}{{A}_{0}} \qquad Equation ( 1 )$$

$${P}_{t} = \frac{{A}_{0} - {A}_{t}}{{A}_{0}} * 100. \qquad Equation ( 2 )$$

A summary of the materials and pyrolytic conditions used for producing high shrinkage PDC materials is given in Table 1.

TABLE 1
Materials and conditions used for producing polymer-derived ceramic materials of Examples 1 to 10.

| | | | | |
|---|---|---|---|---|
| | | Ceramic | Pyrolysis | |
| Ex. | Monomer(s) | particles | conditions | Shrinkage |

Silicon oxycarbide glass-ceramic

| | | | | |
|---|---|---|---|---|
| 1 | 100 parts of (Mercaptopropyl) methylsiloxane homopolymer (ca. 55% | — | Ramp-up: 0.3° C./min | 50% |
| | ceramic yield) and 100 parts of methacryloxypropyl terminated | | 100-600° C.; Tₘₐₓ: | |
| | polydimethylsiloxane (ca. 12% ceramic yield) | | 1300° C.; N₂ | |
| 2 | 100 parts of (Mercaptopropyl) methylsiloxane homopolymer (ca. 55% | — | Ramp-up: 0.3° C./min | 50% |
| | ceramic yield) and 100 parts of methacryloxypropyl terminated | | 100-600° C.; Tₘₐₓ: | |
| | polydimethylsiloxane (ca. 12% ceramic yield) | | 1300° C.; N₂ | |
| 9 | 100 parts of (Mercaptopropyl) methylsiloxane homopolymer (ca. 55% | — | Ramp-up: 0.3° C./min | 50% |
| | ceramic yield) and 100 parts of methacryloxypropyl terminated | | 100-600° C.; Tₘₐₓ: | |
| | polydimethylsiloxane (ca. 12% ceramic yield) | | 1300° C.; N₂ | |

Silicon oxycarbide ceramic

| | | | | |
|---|---|---|---|---|
| 3 | 100 parts of methacryloxypropyl terminated polydimethylsiloxane (ca. | — | Ramp-up: 0.3° C./min | 55% |
| | 12% ceramic yield) with 200 parts of (Mercaptopropyl) methylsiloxane | | 100-600° C.; Tₘₐₓ: | |
| | homopolymer (ca. 55% ceramic yield) | | 1300° C.; N₂ | |
| 4 | 100 parts of methacryloxypropyl terminated polydimethylsiloxane (ca. | 20 parts silica | Ramp-up: 0.3° C./min | 60% |
| | 12% ceramic yield) | nanoparticles | 100-600° C.; Tₘₐₓ: | |
| | | | 1300° C.; N₂ | |
| 5 | 100 parts of methacryloxypropyl terminated polydimethylsiloxane (ca. | 10 parts silica | Ramp-up: 1° C./min | 25% |
| | 12% ceramic yield) with 100 parts of (Mercaptopropyl) methylsiloxane | nanoparticles | 27-1000° C.; Tₘₐₓ: | |
| | homopolymer (ca. 55% ceramic yield) | | 1000° C.; N₂ | |
| 8 | (Comparative Example) 100 parts of methacryloxypropyl terminated | — | Ramp-up: 0.3° C./min | — |
| | polydimethylsiloxane (ca. 12% ceramic yield) | | 100-600° C.; Tₘₐₓ: | |
| | | | 1300° C.; N₂ | |
| 10 | 100 parts of (Mercaptopropyl) methylsiloxane homopolymer (ca. 55% | 5 parts porous silica | Ramp-up: 0.3° C./min | 46% |
| | ceramic yield) and 100 parts of methacryloxypropyl terminated | nanoparticles | 100-600° C.; Tₘₐₓ: | |
| | polydimethylsiloxane (ca. 12% ceramic yield) | | 600° C.; Vacuum | |

Silica ceramic

| | | | | |
|---|---|---|---|---|
| 6 | 100 parts of methacryloxypropyl terminated polydimethylsiloxane (ca. | 10 parts silica | Ramp-up: 1° C./min | 25% |
| | 12% ceramic yield) with 100 parts of (Mercaptopropyl) methylsiloxane | nanoparticles | 27-1000° C.; Tₘₐₓ: | |
| | homopolymer (ca. 55% ceramic yield) | | 1000° C.; O₂ | |
| 7 | 100 parts of methacryloxypropyl terminated polydimethylsiloxane (ca. | 25 parts silica | Ramp-up: 1° C./min | 25% |
| | 12% ceramic yield) with 100 parts of (Mercaptopropyl) methylsiloxane | nanoparticles | 27-1000° C.; Tₘₐₓ: | |
| | homopolymer (ca. 55% ceramic yield) | | 1000° C.; O₂ | |

### Example 1—Silicon Oxycarbide Glass-Ceramic Microfluidic Distributor

A First Functionalised Organosilicon Monomer with High Ceramic Yield+a Second Functionalised Organosilicon Monomer with Low Ceramic Yield Pyrolyzed with Ramp-Up 0.3° C. and Tₘₐₓ 1300° C.

A resin was prepared by mixing 100 parts of (Mercaptopropyl) methylsiloxane homopolymer (ca. 55% ceramic yield) and 100 parts of methacryloxypropyl terminated polydimethylsiloxane (ca. 12% ceramic yield) (i.e. 1:1 weight ratio of first and second functionalised organosilicon monomers) with 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

A bifurcating microfluidic distributor was 3D printed with this resin using a digital light projection (DLP) printer, Miicraft Ultra, as per the manufacturer's standard operating procedure, to produce a 3D-printed green body.

The printed distributor was pyrolysed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

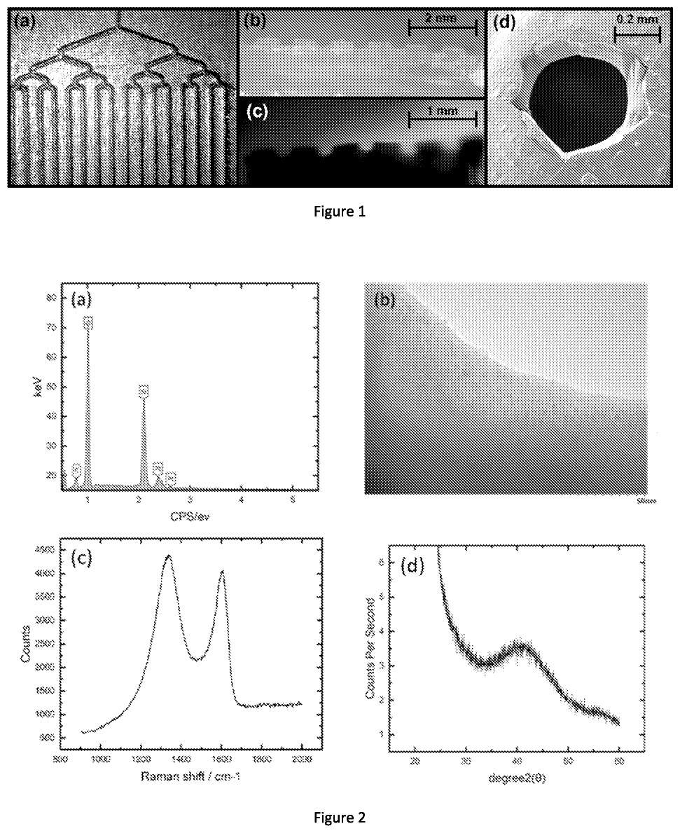

The distributor was designed with 0.5 mm I.D channels and 4 levels of bifurcations at 1400 each resulting in 16 parallel channels. The printed distributor as shown in FIG. 1 (a) (top view) was found to accurately reproduce the design, indicating a reliable print performance of the resin. As shown in FIG. 1 (b), a side view of the printed distributor before pyrolysis suggests the presence of ca. 0.5 mm I.D semi-circular channels, which is often the smallest channel dimensions obtained with low-cost DLP based printers. As shown in FIG. 1 (c) (side view of the pyrolysed distributor), these channels were found to shrink isotopically by 50% resulting in the fabrication of 0.25 mm I.D channels (250±16 μm measured). Similarly, a closed channel with the printed dimension of 845 μm diameter was pyrolysed into a 422 μm diameter channel, as shown in FIG. 1 (d), an SEM image of the closed channel. Hence, a two-fold increase was observed in the resolution and 87.5% decrease was observed in the volume of the here printed microchannels between before and after pyrolysis.

The pyrolyzed material was confirmed to be silicon oxycarbide glass-ceramic by analysis. Energy Dispersive X-ray spectroscopy as shown in FIG. 2 (a) suggested the presence of 35.7 at % Si, 5.7 at % C, 58.4 at % O, and 0.16 at % S in the silica region, which is in line with the elemental composition for silicon oxycarbide glass-ceramic. The transmission electron microscope image as shown in FIG. 2 (b) shows phase separation between silica and carbon. Raman Spectroscopy as shown in FIG. 2 (c) confirmed that carbon was present as free carbon, determined to be 29 wt % interspersed free carbon. X-ray Diffraction Spectroscopy as shown in FIG. 2 (d) showed the silica phase to be amorphous.

The absence of any cracks or pores was confirmed through visual inspection and SEM imaging. Also, BET analysis confirmed the non-porous nature of the sintered objects with a BET surface area of 0 m²/g. The Vicker's hardness and electrical conductivity were found to be 700 Kg/mm² and 600 S/m, respectively, which are in accordance with the hardness and conductivity values expected for silicon oxycarbide glass-ceramics. The density of the pyrolysed structure was measured to be about 2,600 kg/m³.

In a functional group ratio study, the methacryloxypropyl terminated polydimethylsiloxane monomer was titrated with the (mercaptopropyl) methylsiloxane homopolymer monomer, and the effect of different molar ratios of acrylate and thiol functional groups on the reaction kinetics, total percentage polymerisation, and gel point of the resin was studied. Also, the corresponding effect on the weight ratio of the monomers and hence on the ceramic yield of the resin and the structural integrity of the pyrolysed objects were noted.

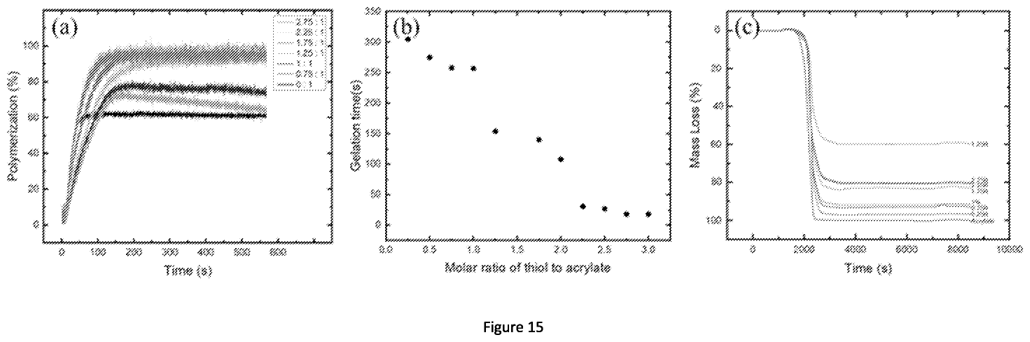

More than a dozen molar ratios of thiol and acrylate functional groups in the range of 0:1 to 3:1 thiol:acrylate were explored. As shown in FIG. 15, methacryloxypropyl terminated polydimethylsiloxane monomer without any (mercaptopropyl) methylsiloxane homopolymer monomer (0:1) (i.e. the resin of Example 8) resulted in less than 65% polymerisation at the gel point and less than 80% total polymerisation. The addition of the (mercaptopropyl) methylsiloxane homopolymer monomer resulted in a concomitant increase in the percentage polymerisation at the gel point and the total polymerisation. Although a complete polymerisation of the acrylates was observed at a 1.25:1 ratio of thiol:acrylate (FIG. 15 (a)), a further increase in the (mercaptopropyl) methylsiloxane homopolymer monomer increased the rate of photo-polymerisation, as evident from a decrease in the gelation point (FIG. 15 (b)) and the time to reach complete polymerisation (FIG. 15 (c)). However, an increase in the amount of (mercaptopropyl) methylsiloxane homopolymer monomer beyond its molar ratio of 1.25:1 resulted in an increase in the amount of its residual in the 3D printed body and did not improve ceramic yield of the pyrolysed objects. As shown in FIG. 15 (c), the 1.25:1 ratio of thiol:acrylate resulted in the highest ceramic yield and the highest structural integrity of the pyrolysed objects.

### Example 2—Silicon Oxycarbide Glass-Ceramic Microneedle Patch

A First Functionalised Organosilicon Monomer with High Ceramic Yield+a Second Functionalised Organosilicon Monomer with Low Ceramic Yield Pyrolyzed with Ramp-Up 0.3° C. and Tₘₐₓ 1300° C.

A resin was prepared by mixing 100 parts of (Mercaptopropyl) methylsiloxane homopolymer (ca. 55% ceramic yield) and 100 parts of methacryloxypropyl terminated polydimethylsiloxane (ca. 12% ceramic yield) (i.e. 1:1 weight ratio of first and second functionalised organosilicon monomers) with 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

A microneedle patch was 3D printed with this resin using a digital light projection (DLP) printer, Miicraft Ultra, as per the manufacturer's standard operating procedure, to produce a 3D-printed green body.

The printed patch was pyrolysed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

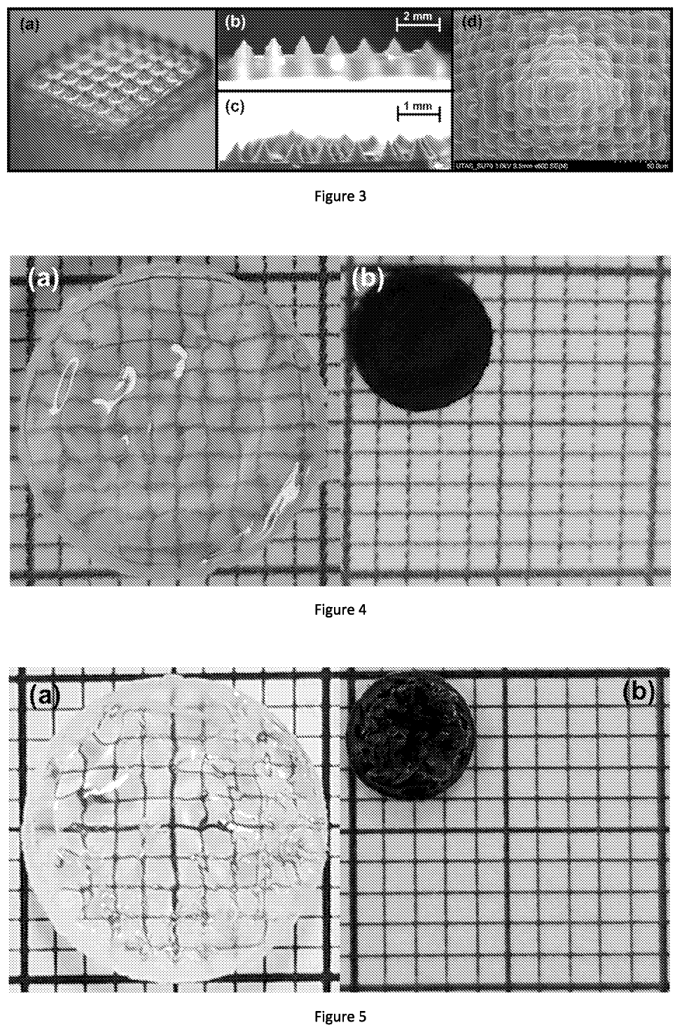

The patch was designed with a 7×7 array of 1 mm height and base and 0.067 mm diameter tip microneedles. The printed microneedle patch as shown in FIG. 3 (a) (top view) was found to accurately reproduce the design, indicating a reliable print performance of the resin. As shown in FIG. 3 (b), a side view of the printed microneedles before pyrolysis suggests the presence of microneedles with ca. 1 mm diameter base and 1 mm height, which is often the smallest microstructure dimensions obtained with low-cost DLP based printers. As shown in FIG. 3 (c) (side view of the pyrolysed microneedle patch), the needles were found to shrink isotopically by 50% resulting in the fabrication of ca. 0.5 mm diameter base (498±23 μm measured) and ca. 0.5 mm height (494±6 μm measured). As shown in FIG. 3 (d) (SEM image of a microneedle), a single pixel resolution was obtained and preserved during printing and pyrolysis steps, where a projected pixel of 30 μm×30 μm resulted in a pyrolysed pixel of ca. 15 μm (16±1 μm measured). Hence, a two-fold increase was observed in the resolution and 87.5% decrease was observed in the volume of the here printed microstructures between before and after pyrolysis.

### Example 3—Silicon Oxycarbide Disc

A First Functionalised Organosilicon Monomer with High Ceramic Yield+a Second Functionalised Organosilicon Monomer with Low Ceramic Yield Pyrolyzed with Ramp-Up 0.3° C. and Tₘₐₓ 1300° C.

A resin was prepared by mixing 100 parts of methacryloxypropyl terminated polydimethylsiloxane (ca. 12% ceramic yield) with 200 parts of (Mercaptopropyl) methylsiloxane homopolymer (ca. 55% ceramic yield) (i.e. 1:2 weight ratio of first and second functionalised organosilicon monomers), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc-shaped mould (10 mm diameter and 2 mm thickness) to produce a 3D-printed green body.

The produced green body was pyrolyzed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

As shown in FIG. 4, pyrolysis of the green bodies (FIG. 4 (a)) into silicon oxycarbide (FIG. 4 (b)) retained all the features of the moulded structures and resulted in ca. 55% linear shrinkage and ca. 91% volumetric shrinkage.

### Example 4—Silicon Oxycarbide Disc

A First Functionalised Organosilicon Monomer with Low Ceramic Yield+Ceramic Particles Pyrolyzed with Ramp-Up 0.3° C. and Tₘₐₓ 1300° C.

A resin was prepared by mixing 100 parts of methacryloxypropyl terminated polydimethylsiloxane (ca. 12% ceramic yield) with 20 parts non-porous silica nanoparticles (10-20 nm particle size), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc (10 mm diameter and 2 mm thickness) shaped mould to produce a 3D-printed green body.

The produced green body was pyrolysed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

As shown in FIG. 5, pyrolysis of the green bodies (FIG. 5 (a)) into silicon oxycarbide (FIG. 5 (b)) retained all the features of the moulded structures and resulted in ca. 60% linear shrinkage and ca. 94% volumetric shrinkage.

### Example 5—Silicon Oxycarbide Block

A First Functionalised Organosilicon Monomer with High Ceramic Yield+a Second Functionalised Organosilicon Monomer with Low Ceramic Yield+Ceramic Particles Pyrolyzed with Ramp-Up 1° C. and Tₘₐₓ 1000° C.

A resin was prepared by mixing 100 parts of methacryloxypropyl terminated polydimethylsiloxane (ca. 12% ceramic yield) with 100 parts of (Mercaptopropyl) methylsiloxane homopolymer (ca. 55% ceramic yield) (i.e. 1:1 weight ratio of first and second functionalised organosilicon monomers), 10 parts non-porous silica nanoparticles (10-20 nm particle size), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D-printed green body.

The produced green body was pyrolysed under nitrogen in a tube furnace. The pyrolysis was performed with a ramp rate of 1° C./min from 27° C. to 1000° C., followed by holding at 1000° C. for 60 minutes. It was then cooled down to 27° C. at a ramp rate of 1° C./min.

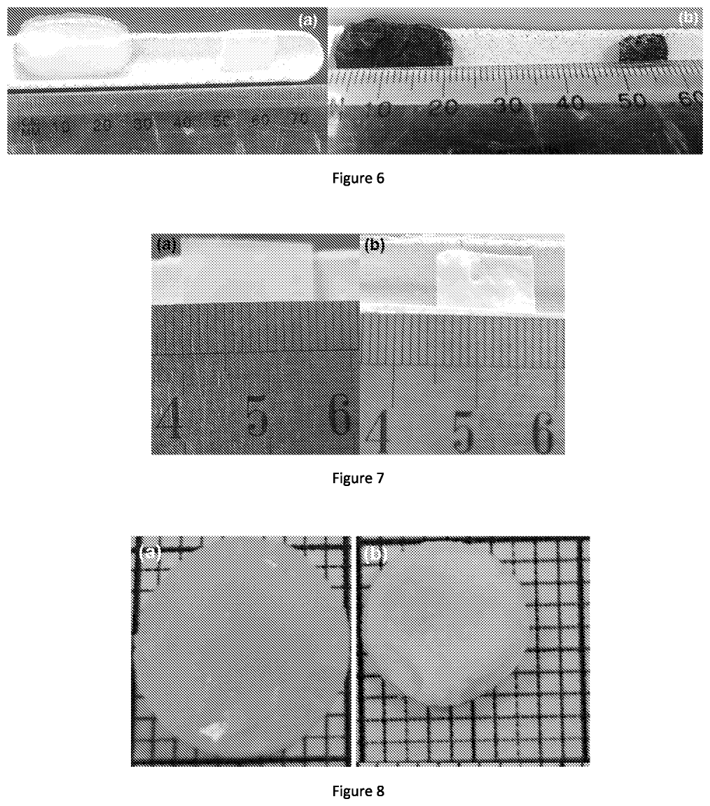

As shown in FIG. 6, pyrolysis of the green bodies (FIG. 6 (a)) into silicon oxycarbide (FIG. 6 (b)) retained all the features of the printed structures and resulted in ca. 25% linear shrinkage and ca. 58% volumetric shrinkage.

### Example 6—Silica Block

A First Functionalised Organosilicon Monomer with High Ceramic Yield+a Second Functionalised Organosilicon Monomer with Low Ceramic Yield+Ceramic Particles Pyrolyzed with Ramp-Up 1° C. and Tₘₐₓ 1000° C.

A polydimethylsiloxane (ca. 12% ceramic yield) with 100 parts of (Mercaptopropyl) methylsiloxane homopolymer (ca. 55% ceramic yield) (i.e. 1:1 weight ratio of first and second functionalised organosilicon monomers), 10 parts non-porous silica nanoparticles (10-20 nm particle size), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was 3D printed using a digital light projection (DLP) printer, Miicraft Ultra, as per the manufacturer's standard operating procedure to produce a 3D-printed green body.

The produced green body was pyrolysed under oxygen in a tube furnace. The pyrolysis was performed with a ramp rate of 1° C./min from 27° C. to 1000° C., followed by holding at 1000° C. for 60 minutes. It was then cooled down to 27° C. at a ramp rate of 1° C./min.

As shown in FIG. 7, pyrolysis of the green bodies (FIG. 7 (a)) into silica (FIG. 7 (b)) retained all the features of the printed structures and resulted in ca. 25% linear shrinkage and ca. 58% volumetric shrinkage.

### Example 7—Silica Disc

A First Functionalised Organosilicon Monomer with High Ceramic Yield+a Second Functionalised Organosilicon Monomer with Low Ceramic Yield+Ceramic Particles Pyrolyzed with Ramp-Up 1° C. and Tₘₐₓ 1000° C.

A resin was prepared by mixing 100 parts of methacryloxypropyl terminated polydimethylsiloxane (ca. 12% ceramic yield) with 100 parts of (Mercaptopropyl) methylsiloxane homopolymer (ca. 55% ceramic yield), 25 parts non-porous silica nanoparticles (10-20 nm particle size), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc (10 mm diameter and 2 mm thickness) shaped mould to produce a 3D-printed green body.

The produced green body was pyrolysed under oxygen in a tube furnace. The pyrolysis was performed with a ramp rate of 1° C./min from 27° C. to 1000° C., followed by holding at 1000° C. for 60 minutes. It was then cooled down to 27° C. at a ramp rate of 1° C./min.

As shown in FIG. 8, pyrolysis of the green bodies (FIG. 8 (a)) into silica (FIG. 8 (b)) retained all the features of the printed structures and resulted in ca. 25% linear shrinkage and ca. 58% volumetric shrinkage.

### Example 8—Comparative—Silicon Oxycarbide

A First Functionalised Organosilicon Monomer with Low Ceramic Yield Pyrolyzed with Ramp-Up 0.3° C. and Tₘₐₓ 1300° C.

A resin was prepared by mixing 100 parts of methacryloxypropyl terminated polydimethylsiloxane (ca. 12% ceramic yield) with 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

The resin was photopolymerised under 365 nm wavelength by casting it into a disc (10 mm diameter and 2 mm thickness) shaped mould to produce a 3D-printed green body.

The produced green body was pyrolysed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

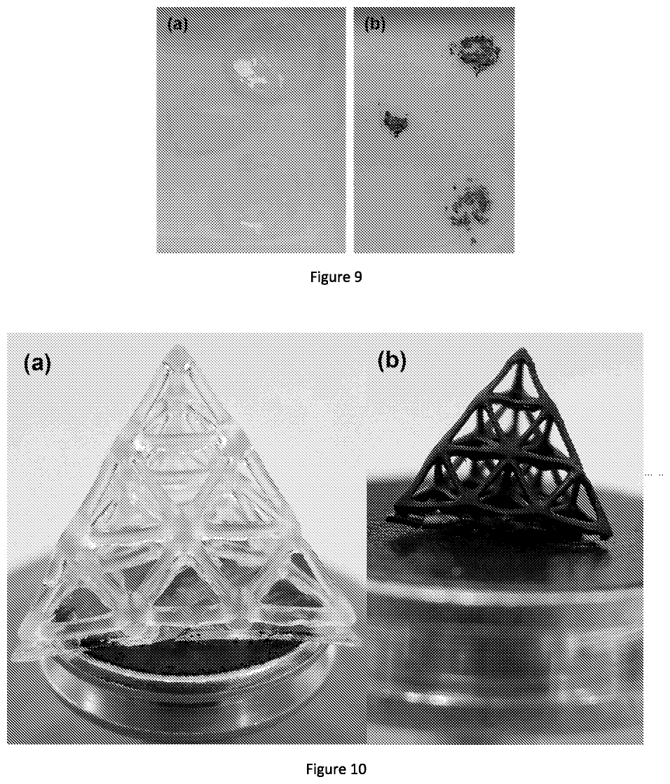

As shown in FIG. 9, pyrolysis of the green bodies (FIG. 9 (a)) into silicon oxycarbide (FIG. 9 (b)) does not retain the shape or the structural integrity of the green body.

### Example 9—Silicon Oxycarbide Glass-Ceramic Microstructure Scaffold

A First Functionalised Organosilicon Monomer with High Ceramic Yield+a Second Functionalised Organosilicon Monomer with Low Ceramic Yield Pyrolyzed with Ramp-Up 0.3° C. and Tₘₐₓ 1300° C.

A resin was prepared by mixing 100 parts of (Mercaptopropyl) methylsiloxane homopolymer (ca. 55% ceramic yield) and 100 parts of methacryloxypropyl terminated polydimethylsiloxane (ca. 12% ceramic yield) (i.e. 1:1 weight ratio of first and second functionalised organosilicon monomers) with 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

A pyramid with a microstructure scaffold was 3D printed with this resin using a digital light projection (DLP) printer, Miicraft Ultra, as per the manufacturer's standard operating procedure, to produce a 3D-printed green body.

The printed pyramid was pyrolysed under constant (3 L/min) nitrogen flow in a tube furnace. The pyrolysis was performed with a ramp rate of 1° C./min from 20° C. to 100° C., followed by 0.3° C./min from 100° C. to 600° C. and holding at 600° C. for 180 minutes. It was followed by further ramping at 7° C./min up to 1300° C. while holding at 850 and 1150° C. for 60 minutes each. The temperature was held at 1300° C. for 60 minutes followed by cooling to 500° C. at a ramp rate of 7° C./min while holding at 850 and 500° C. for 60 minutes each. It was then cooled down to 20° C. at a ramp rate of 2° C./min while holding at 300° C. for 60 minutes.

The printed pyramid was designed with an equilateral triangular scaffold, each arm of the triangles making up the scaffold being 3.9 mm in length, and with a total height of the pyramid being 10 mm. The printed pyramid was levitated 1 mm from the base. The printed pyramid as shown in FIG. 10 (a) (side view) was found to accurately reproduce the design, indicating a reliable print performance of the resin. Shown in FIG. 10 (b) is a side view of the pyrolysed pyramid. The total height of the pyrolyzed pyramid was found to be 5 mm and each arm of the triangles making up the scaffold was found to be 2 mm. Hence, a two-fold increase was observed in the resolution and 87.5% decrease was observed in the volume of the here printed microstructure between before and after pyrolysis.

### Example 10—Silicon Oxycarbide Porous Microfluidic Chip

A First Functionalised Organosilicon Monomer with High Ceramic Yield+a Second Functionalised Organosilicon Monomer with Low Ceramic Yield+Porous Ceramic Particles Pyrolyzed with Ramp-Up 0.3° C. and Tₘₐₓ 600° C.

A resin was prepared by mixing 100 parts of methacryloxypropyl terminated polydimethylsiloxane (ca. 12% ceramic yield) with 100 parts of (Mercaptopropyl) methylsiloxane homopolymer (ca. 55% ceramic yield) (i.e. 1:1 weight ratio of first and second functionalised organosilicon monomers) with 5 parts of porous silica nanoparticles (10-20 nm particle size), 0.4 parts of phenylbis (2,4,6-trimethylbenzoyl) phosphine oxide (BAPO), 0.23 parts of 2,5-Bis (5-tert-butyl-benzoxazol-2-yl) thiophene (BBOT), and 0.8 parts of w/w tert-Butylhydroquinone (TBHQ).

The resin components were mixed thoroughly on a vortex mixer and sonicator bath, and then the prepared resin was purged with nitrogen and vacuumed for an hour.

A microfluidic chip was 3D printed with this resin using a digital light projection (DLP) printer, Miicraft Ultra, as per the manufacturer's standard operating procedure, to produce a 3D-printed green body.

The printed chip was pyrolyzed under a vacuum in a tube furnace. The pyrolysis was performed with a ramp rate of 1° C./min from 25° C. to 100° C., followed by 0.5° C./min from 100° C. to 600° C. The temperature was held at 600° C. for 180 minutes followed by cooling to 450° C. at a ramp rate of 2° C./min and holding for 60 minutes, then cooling to 300° C. at a ramp rate of 2° C./min and holding for 60 minutes. Cooled then continued to 25° C. at a ramp rate of 2° C./min.

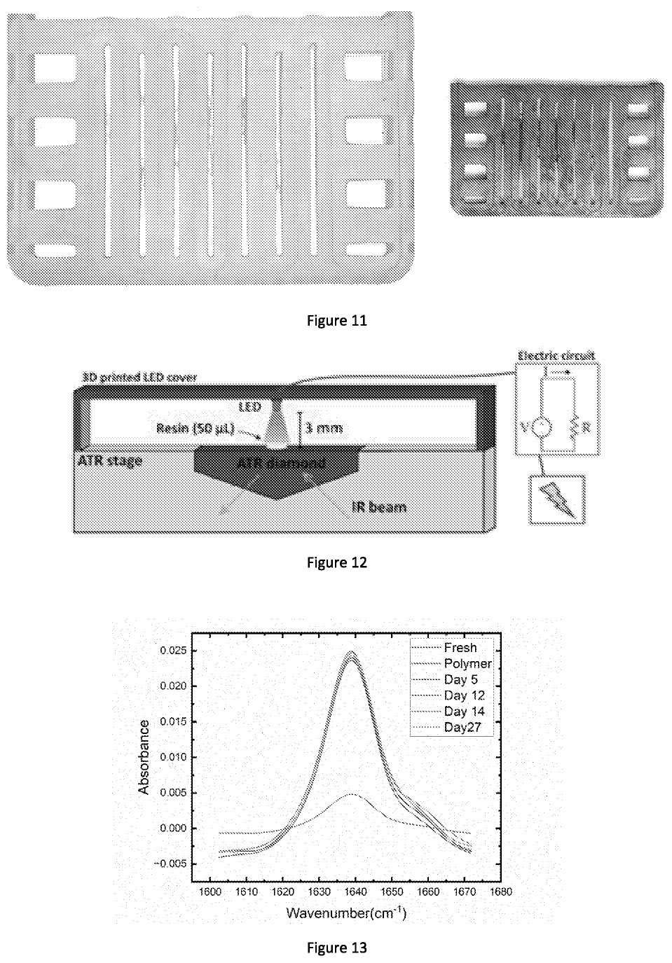

The microfluidic chip was designed with a 360 μm I.D and 100 mm long cylindrical channel as shown in FIG. 11 (left). The I.D of the obtained channel was 354 μm. After pyrolysis, as shown in FIG. 11, the channel diameter shrunk to 190 μm. A 1.8-fold increase was observed in the resolution and 84.2% decrease was observed in the volume of the microfluidic chip between before and after pyrolysis.

### Example 11—Study of Resin Shelf-Life

### Methods

Using RT-FTIR spectroscopy, the resin as exemplified in Examples 1 and 2 were studied over 27 days to understand their stability when stored at 4° C. The changes in C═C (1620 cm⁻¹), C═O (1750-1690 cm⁻¹), Si—(CH₃)₂ (1335-1280 cm⁻¹), and Si—O—Si (1163 cm⁻¹) bonds at different time points were studied.

### Results

The results are presented in FIG. 13. The resin did not show any signs of degradation during the course of this study. A similar result was found for the gel point (time to reach gelation during photo-polymerisation). The resins stored at 4° C. did not show any significant change in their gel point throughout this study. The study shows that, when stored at cool temperatures, the stability of the exemplified resins containing first and second functionalised organosilicon monomers is not diminished.

### Example 12—Study of Resin Oxygen-Resistance

### Methods

Oxygen resistance of the resin as exemplified in Examples 1 and 2 and the resin as exemplified in Example 8, was studied. The resins were prepared with BAPO but not TBHQ or BBOT so as to minimize effects of additives.

A cylindrical mould with an internal diameter of 10 mm and a height of 2 mm was designed and 3D printing. The mould's interior surface was sprayed with a Teflon spray to minimise resin adhesion. An approximately 160 μL of sample volume was transferred to the mould and then exposed to 365 nm wavelength light using a UV crosslinker. The polymerisation percentage for these resins was also studied using real time FTIR.

### Results

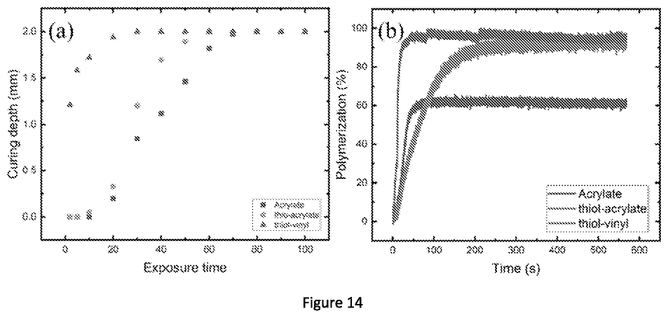

The curing depth and the polymerisation percentage was observed with respect to the exposure time. FIG. 14 shows a much more controlled and rapid curing of the resin of Examples 1 and 2 as compared with the resin of Example 8, which is an advantage for photo-polymerisation-based 3D printing. The study demonstrates the rapid and controlled curing of exemplified resins of Examples 1 and 2 as compared with the resin of Example 8.

The above examples are only the preferred examples of the present disclosure. It shall be pointed out that various improvements and modifications could be made by those ordinarily skilled in the art without deviating from the principle of the present disclosure, which shall fall within the protection scope of the present disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein, except where the context requires otherwise due to express language or necessary implication, the articles “a” and “an” are used herein to refer to one or to more than one (i.e. to at least one) of the grammatical object of the article. By way of example, “an element” means one element or more than one element.

1-52. (canceled)

53. A preceramic resin for forming a polymer-derived ceramic material, said resin comprising a first functionalised organosilicon monomer having a first ceramic yield of no greater than 50%, and one or more of:
a) a second functionalised organosilicon monomer having a second ceramic yield, wherein the second ceramic yield is greater than the first ceramic yield by at least 5%; and
b) ceramic particles.

54. The preceramic resin according to claim 53, wherein the first ceramic yield is a ceramic yield which is less than or equal to 30%, and/or wherein the second ceramic yield is greater than the first ceramic yield by 10% or more.

55. The preceramic resin according to claim 53, wherein the first functionalised organosilicon monomer is based on an organosilicon monomer independently selected from the group consisting of:
a polysiloxane, polycarbosiloxane, polycarbosilane, polysilylcarbodiimide and a polysilazane having the following chemical structures of Formula 1, Formula 2, Formula 3, Formula 4 and Formula 5, respectively, 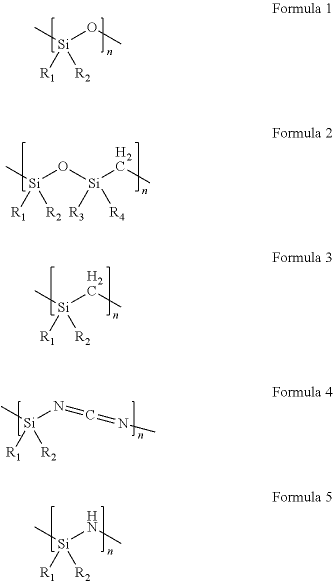
wherein:
n represents a backbone structure of repeating silicon atom-containing motifs and is independently an integer of from 2 to 15; and
R₁, R₂, R₃ and R₄ are independently selected from the group consisting of H, a C₁-C₁₈ substituted or unsubstituted alkyl, a C₁-C₁₈ substituted or unsubstituted alkyl ether, a phenyl and a halide, independently for each integer of n, with the proviso that the pairs of R₁ and R₂ and R₃ and R₄ are not both H, alkyl ether or halide for every integer of n, preferably wherein the pairs of R₁ and R₂ and R₃ and R₄ are not both H, alkyl ether or halide for any integer of n, and preferably wherein each of R₁ and R₂ and R₃ and R₄ are identical for every integer of n;
a polysilsesquioxane, polysilsesquicarbodiimide and a polysilsesquiazane substituted with one or more groups selected from the group consisting of a C₁-C₁₈ substituted or unsubstituted alkyl, a C₁-C₁₈ substituted or unsubstituted alkyl ether, a phenyl and a halide; and
a polyborosilane, a polyborosiloxane and a polyborosilazane having the following chemical structures of Formula 6, Formula 7 and Formula 8, respectively, 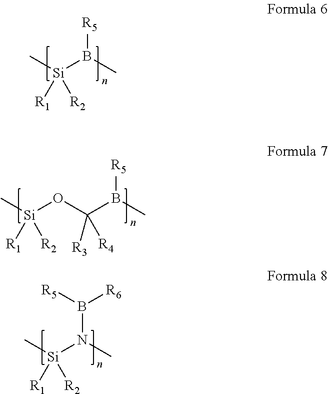
wherein:
n represents a backbone structure of repeating silicon atom-containing motifs and is independently an integer of from 2 to 15;
R₁, R₂, R₃ and R₄ are as defined above; and
R₅ and R₆ are independently selected from the group consisting of H, OH, a C₁-C₁₈ substituted or unsubstituted alkyl, a C₁-C₁₈ substituted or unsubstituted alkyl ether and a phenyl, independently for each integer of n, and preferably wherein R₅ and R₆ are identical for every integer of n.

56. The preceramic resin according to claim 53, wherein the first functionalised organosilicon monomer is functionalised with a thermal- and/or photopolymerisable functional group.

57. The preceramic resin according to claim 53, wherein the first functionalised organosilicon monomer is a polysiloxane methacryloxypropyl terminated polydimethylsiloxane.

58. The preceramic resin according to claim 53, wherein the second functionalised organosilicon monomer is present and contains a polymerisable functional group that is different from, though complementary to, a polymerisable functional group of the first functionalised organosilicon monomer.

59. The preceramic resin according to claim 53, wherein the second functionalised organosilicon monomer is present and is a polysiloxane (mercaptopropyl) methylsiloxane homopolymer.

60. The preceramic resin according to claim 53, wherein the first functionalised organosilicon monomer and the second functionalised organosilicon monomers are present in the preceramic resin in a 1:1 to 1:2 ratio in respect of their polymerisable functional groups.

61. The preceramic resin according to claim 53, wherein the second functionalised organosilicon monomer is present, and wherein one of the first functionalised organosilicon monomer and the second functionalised organosilicon monomer is functionalised with an acrylate polymerisable functional group and the other is functionalised with a thiol polymerisable functional group.

62. The preceramic resin according to claim 53, wherein the ceramic particles are present, optionally wherein at least 90% of the ceramic particles have a size of between about 1 nm to about 1 mm, as determined using TEM.

63. A polymer-derived ceramic material formed from a preceramic resin according to claim 53.

64. The polymer-derived ceramic material according to claim 63, formed by pyrolysis of a green body, characterised by a linear shrinkage of greater than or equal to 30% and a volumetric shrinkage of greater than or equal to about 66%.

65. The polymer-derived ceramic material according to claim 63, wherein the polymer-derived ceramic material comprises silica, formed by pyrolysis of a green body, characterised by a linear shrinkage of greater than or equal to 20% and a volumetric shrinkage of greater than or equal to about 49%.

66. The polymer-derived ceramic material according to claim 63, wherein the polymer-derived ceramic material comprises a glass-ceramic material.

67. A method for forming a polymer-derived ceramic material, said method comprising:
a) subjecting a preceramic resin according to claim 53 to polymerising conditions to form a preceramic polymer; and
b) subjecting the preceramic polymer to pyrolytic conditions to form a polymer-derived ceramic material.

68. A method according to claim 67, wherein formation of the polymer-derived ceramic material from the preceramic polymer proceeds through a porous phase, and wherein the pyrolytic conditions comprise a temperature ramp-up rate of no greater than 10° C./minute for a period within the porous phase.

69. A method according to claim 67, wherein the pyrolytic conditions comprise a temperature ramp-up rate of no greater than 10° C./minute for a period within the temperature range of 200 to 900° C.

70. A method according to claim 67, wherein the pyrolytic conditions comprise a maximum temperature of less than a porosity transition temperature of the polymer-derived ceramic material.

71. A method according to claim 67, wherein the pyrolytic conditions comprise a minimum temperature of no less than the porosity transition temperature.

72. A method according to claim 67, further comprising a preliminary step of shaping the preceramic resin using a 3D printer.
